(19) United States
(12) Patent Application Publication
(10) Pub. No.: US 2025/0310957 A1
(43) Pub. Date: Oct. 2, 2025

(54) LOGICAL CHANNEL PRIORITIZATION RESTRICTIONS

(71) Applicant: QUALCOMM Incorporated, San Diego, CA (US)

(72) Inventor: Linhai HE, San Diego, CA (US)

(21) Appl. No.: 19/058,317

(22) Filed: Feb. 20, 2025

Related U.S. Application Data
(60) Provisional application No. 63/573,211, filed on Apr. 2, 2024.

(51) Int. Cl. H04W 72/1268; H04W 72/0453; H04W 72/566

(52) U.S. Cl. CPC H04W 72/1268; H04W 72/0453; H04W 72/566

(57) ABSTRACT

Various aspects of the present disclosure generally relate to wireless communication. In some aspects, a user equipment (UE) may receive, from a network node, a logical channel configuration indicating one or more allowable control resource set (CORESET) groups for a logical channel. The UE may receive an uplink grant indicating one or more uplink resources, wherein the uplink grant is associated with a CORESET group. The UE may transmit, using the one or more uplink resources, uplink data that is associated with the logical channel, wherein the uplink data being transmitted using the one or more uplink resources is based at least in part on the CORESET group being included in the one or more allowable CORESET groups. Numerous other aspects are described.

### CROSS-REFERENCE TO RELATED APPLICATION

The present Application for Patent claims priority under 35 U.S.C. § 119 to U.S. Provisional Patent Application No. 63/573,211, filed on Apr. 2, 2024, entitled “LOGICAL CHANNEL PRIORITIZATION RESTRICTIONS,” which is assigned to the assignee hereof and hereby expressly incorporated by reference herein.

### FIELD OF THE DISCLOSURE

Aspects of the present disclosure generally relate to wireless communication and specifically relate to techniques, apparatuses, and methods associated with logical channel prioritization restrictions.

### DESCRIPTION OF RELATED ART

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

In some aspects, an apparatus for wireless communication includes one or more memories; and one or more processors coupled to the one or more memories, the one or more processors individually or collectively configured to: receive, from a network node, a logical channel configuration indicating one or more allowable control resource set (CORESET) groups for a logical channel; receive an uplink grant indicating one or more uplink resources, wherein the uplink grant is associated with a CORESET group; and transmit, using the one or more uplink resources, uplink data that is associated with the logical channel, wherein the uplink data being transmitted using the one or more uplink resources is based at least in part on the CORESET group being included in the one or more allowable CORESET groups.

In some aspects, an apparatus for wireless communication includes one or more memories; and one or more processors coupled to the one or more memories, the one or more processors individually or collectively configured to: receive, from a network node, a logical channel configuration indicating a conditional logical channel prioritization parameter for a logical channel, wherein the logical channel configuration indicates a threshold for a parameter associated with the conditional logical channel prioritization parameter; and transmit, via the logical channel, uplink data in accordance with the conditional logical channel prioritization parameter, wherein an applicability of the conditional logical channel prioritization parameter to the logical channel is based at least in part on a value of the parameter for the uplink data satisfying the threshold.

In some aspects, a method of wireless communication performed by a user equipment (UE) includes receiving, from a network node, a logical channel configuration indicating one or more allowable CORESET groups for a logical channel; receiving an uplink grant indicating one or more uplink resources, wherein the uplink grant is associated with a CORESET group; and transmitting, using the one or more uplink resources, uplink data that is associated with the logical channel, wherein the uplink data being transmitted using the one or more uplink resources is based at least in part on the CORESET group being included in the one or more allowable CORESET groups.

In some aspects, a method of wireless communication performed by a UE includes receiving, from a network node, a logical channel configuration indicating a conditional logical channel prioritization parameter for a logical channel, wherein the logical channel configuration indicates a threshold for a parameter associated with the conditional logical channel prioritization parameter; and transmitting, via the logical channel, uplink data in accordance with the conditional logical channel prioritization parameter, wherein an applicability of the conditional logical channel prioritization parameter to the logical channel is based at least in part on a value of the parameter for the uplink data satisfying the threshold.

In some aspects, a non-transitory computer-readable medium storing a set of instructions for wireless communication includes one or more instructions that, when executed by one or more processors of a UE, cause the UE to: receive, from a network node, a logical channel configuration indicating one or more allowable CORESET groups for a logical channel; receive an uplink grant indicating one or more uplink resources, wherein the uplink grant is associated with a CORESET group; and transmit, using the one or more uplink resources, uplink data that is associated with the logical channel, wherein the uplink data being transmitted using the one or more uplink resources is based at least in part on the CORESET group being included in the one or more allowable CORESET groups.

In some aspects, a non-transitory computer-readable medium storing a set of instructions for wireless communication includes one or more instructions that, when executed by one or more processors of an UE, cause the UE to: receive, from a network node, a logical channel configuration indicating a conditional logical channel prioritization parameter for a logical channel, wherein the logical channel configuration indicates a threshold for a parameter associated with the conditional logical channel prioritization parameter; and transmit, via the logical channel, uplink data in accordance with the conditional logical channel prioritization parameter, wherein an applicability of the conditional logical channel prioritization parameter to the logical channel is based at least in part on a value of the parameter for the uplink data satisfying the threshold.

In some aspects, an apparatus for wireless communication includes means for receiving, from a network node, a logical channel configuration indicating one or more allowable CORESET groups for a logical channel; means for receiving an uplink grant indicating one or more uplink resources, wherein the uplink grant is associated with a CORESET group; and means for transmitting, using the one or more uplink resources, uplink data that is associated with the logical channel, wherein the uplink data being transmitted using the one or more uplink resources is based at least in part on the CORESET group being included in the one or more allowable CORESET groups.

In some aspects, an apparatus for wireless communication includes means for receiving, from a network node, a logical channel configuration indicating a conditional logical channel prioritization parameter for a logical channel, wherein the logical channel configuration indicates a threshold for a parameter associated with the conditional logical channel prioritization parameter; and means for transmitting, via the logical channel, uplink data in accordance with the conditional logical channel prioritization parameter, wherein an applicability of the conditional logical channel prioritization parameter to the logical channel is based at least in part on a value of the parameter for the uplink data satisfying the threshold.

In some aspects, an apparatus for wireless communication includes one or more memories; and one or more processors coupled to the one or more memories, the one or more processors individually or collectively configured to: transmit a logical channel configuration, for a UE, indicating one or more allowable CORESET groups for a logical channel; transmit an uplink grant for the UE indicating one or more uplink resources, wherein the uplink grant is associated with a CORESET group; and receive, via the one or more uplink resources, uplink data that is associated with the logical channel, wherein the uplink data being received using the one or more uplink resources is based at least in part on the CORESET group being included in the one or more allowable CORESET groups.

In some aspects, an apparatus for wireless communication includes one or more memories; and one or more processors coupled to the one or more memories, the one or more processors individually or collectively configured to: transmit a logical channel configuration indicating a conditional logical channel prioritization parameter for a logical channel, wherein the logical channel configuration indicates a threshold for a parameter associated with the conditional logical channel prioritization parameter; and receive, via the logical channel, uplink data in accordance with the conditional logical channel prioritization parameter, wherein an applicability of the conditional logical channel prioritization parameter to the logical channel is based at least in part on a value of the parameter for the uplink data satisfying the threshold.

In some aspects, a method of wireless communication performed by a network node includes transmitting a logical channel configuration, for a UE, indicating one or more allowable CORESET groups for a logical channel; transmitting an uplink grant for the UE indicating one or more uplink resources, wherein the uplink grant is associated with a CORESET group; and receiving, via the one or more uplink resources, uplink data that is associated with the logical channel, wherein the uplink data being received using the one or more uplink resources is based at least in part on the CORESET group being included in the one or more allowable CORESET groups.

In some aspects, a method of wireless communication performed by a network node includes transmitting a logical channel configuration indicating a conditional logical channel prioritization parameter for a logical channel, wherein the logical channel configuration indicates a threshold for a parameter associated with the conditional logical channel prioritization parameter; and receiving, via the logical channel, uplink data in accordance with the conditional logical channel prioritization parameter, wherein an applicability of the conditional logical channel prioritization parameter to the logical channel is based at least in part on a value of the parameter for the uplink data satisfying the threshold.

In some aspects, a non-transitory computer-readable medium storing a set of instructions for wireless communication includes one or more instructions that, when executed by one or more processors of a network node, cause the network node to: transmit a logical channel configuration, for a UE, indicating one or more allowable CORESET groups for a logical channel; transmit an uplink grant for the UE indicating one or more uplink resources, wherein the uplink grant is associated with a CORESET group; and receive, via the one or more uplink resources, uplink data that is associated with the logical channel, wherein the uplink data being received using the one or more uplink resources is based at least in part on the CORESET group being included in the one or more allowable CORESET groups.

In some aspects, a non-transitory computer-readable medium storing a set of instructions for wireless communication includes one or more instructions that, when executed by one or more processors of a network node, cause the network node to: transmit a logical channel configuration indicating a conditional logical channel prioritization parameter for a logical channel, wherein the logical channel configuration indicates a threshold for a parameter associated with the conditional logical channel prioritization parameter; and receive, via the logical channel, uplink data in accordance with the conditional logical channel prioritization parameter, wherein an applicability of the conditional logical channel prioritization parameter to the logical channel is based at least in part on a value of the parameter for the uplink data satisfying the threshold.

In some aspects, an apparatus for wireless communication includes means for transmitting a logical channel configuration, for a UE, indicating one or more allowable CORESET groups for a logical channel; means for transmitting an uplink grant for the UE indicating one or more uplink resources, wherein the uplink grant is associated with a CORESET group; and means for receiving, via the one or more uplink resources, uplink data that is associated with the logical channel, wherein the uplink data being received using the one or more uplink resources is based at least in part on the CORESET group being included in the one or more allowable CORESET groups.

In some aspects, an apparatus for wireless communication includes means for transmitting a logical channel configuration indicating a conditional logical channel prioritization parameter for a logical channel, wherein the logical channel configuration indicates a threshold for a parameter associated with the conditional logical channel prioritization parameter; and means for receiving, via the logical channel, uplink data in accordance with the conditional logical channel prioritization parameter, wherein an applicability of the conditional logical channel prioritization parameter to the logical channel is based at least in part on a value of the parameter for the uplink data satisfying the threshold.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example network node in communication with an example user equipment (UE) in a wireless network, in accordance with the present disclosure.

FIG. 3 is a diagram illustrating an example disaggregated base station architecture in accordance with the present disclosure.

FIG. 4 is a diagram illustrating an example associated with logical channel prioritization, in accordance with the present disclosure.

FIG. 5 is a diagram of an example associated with logical channel prioritization restrictions, in accordance with the present disclosure.

FIG. 6 is a diagram illustrating an example process performed, for example, at a UE or an apparatus of a UE, in accordance with the present disclosure.

FIG. 7 is a diagram illustrating an example process performed, for example, at a UE or an apparatus of a UE, in accordance with the present disclosure.

FIG. 8 is a diagram illustrating an example process performed, for example, at a network node or an apparatus of a network node, in accordance with the present disclosure.

FIG. 9 is a diagram illustrating an example process performed, for example, at a network node or an apparatus of a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

In some examples, a user equipment (UE) may schedule or allocate data to available uplink resources via logical channel (LCH) prioritization. As used herein, “logical channel” or “LCH” may refer to a channel between a radio link control (RLC) layer and a medium access control (MAC) layer that facilitates downlink communications from a network node to a UE and uplink communications from the UE to the network node. An LCH may reside in the control plane and carry control information or may reside in the user plane and carry data. For example, the network node may transmit, and the UE may receive, configuration information that includes an LCH configuration for one or more LCHs. The LCH configuration may indicate a priority (for example, an LCH priority) for the LCH associated with the LCH configuration. The priority may be an integer value (for example, where a lower integer value indicates a higher priority).

In some examples, the network node may configure one or more restrictions for an LCH, each of which may be referred to herein as a “logical channel prioritization (LCP) restriction.” An LCP restriction may define, or otherwise fix, one or more criteria or rules for whether traffic for an LCH can be considered for transmission via given radio resources (e.g., uplink resources). “LCP restriction” may be used herein interchangeably with “LCP parameter.” An LCP restriction may indicate whether a given LCH can be considered by the UE during an LCP operation based on, or otherwise associated with, one or more parameters of the radio resources that are being filled by the UE. An LCP operation may include the UE selecting traffic from one or more LCHs to be transmitted via available radio resources (e.g., uplink resources) based on, or otherwise associated with, LCH priorities of respective LCHs of the one or more LCHs.

For example, the network node may identify traffic that is delay-sensitive (for example, traffic for an extended reality (XR) application). Accordingly, the network node may determine a restriction for an LCH, to which the delay-sensitive traffic is assigned, that will route the delay-sensitive traffic to a physical channel (for example, to a transmission reception point (TRP) associated with the network node) with higher data rate (for example, lower data load). In another example, the network node may identify traffic that is error-sensitive (for example, pose updates for an XR application). Accordingly, the network node may determine a restriction for an LCH, to which the error-sensitive traffic is assigned, that will route the error-sensitive traffic to a TRP or radio unit (RU) associated with the network node with greater robustness (for example, higher quality and/or reliability). In another example, the network node may identify an LCH associated with control information for the UE. Accordingly, the network node may determine a restriction for the LCH, to which the control information is assigned, that will route the control information to a TRP of the network node with greater robustness (for example, higher quality and/or reliability).

For example, an application (such as an XR application or a virtual reality (VR) application) may generate audio data, video data, positioning data, haptic data, and/or other types of data that are each associated with the application. The different types of uplink flows may be associated with different quality of service (QoS) requirements. For example, video data may be associated with a high data rate, an average reliability requirement (e.g., 99%), and/or an average latency requirement (e.g., 50 milliseconds for uplink). Haptic data or control data may be associated with a low data rate, a high reliability requirement (e.g., 99.99%), and/or a stringent latency requirement (e.g., 20 milliseconds for uplink). The different types of uplink flows may be better served using different radio resources of the wireless communication network (for example, different TRPs, different RUs, or different network nodes). For example, a TRP or RU may be deployed near a cell edge. The TRP or RU may enable improved coverage and throughput for UEs located near the cell edge. However, traffic routed through the TRP or RU may experience additional delays or latency (e.g., as compared to traffic that is transmitted directly to a network node or directly to a base station or distributed unit (DU), such as to a TRP or RU that is co-located with the base station or the DU). Therefore, it may be beneficial to route traffic that has higher data rates and is less sensitive to latency through the TRP or RU (e.g., to achieve a higher throughput for the traffic), such as for video traffic. For other types of traffic, such as haptic data, control data, or other types of data that are delay sensitive, it may be beneficial to route the traffic directly to a network node (e.g., a base station or DU) to reduce the delay or latency for the traffic.

As another example, TRPs or RUs serving respective carriers on different bands (such as in an inter-band carrier aggregation scenario) may not be co-located. For example, traffic for a given carrier may be routed to a network node (e.g., to a base station or a DU) via one or more midhaul links or one or more backhaul links. In such examples, it may be beneficial to route different types of traffic to different carriers based on, or otherwise associated with, the QoS requirements of the different types of traffic.

The UE may select one or more LCHs to transmit traffic to the network node. For example, the UE may select traffic associated with the one or more LCHs to fill available resources for an uplink transmission (for example, to fill a MAC protocol data unit (PDU)). The one or more LCHs may be LCHs that are available for use for the available resources in accordance with LCP restrictions configured for the LCHs. The UE may select the one or more LCHs based on, responsive to, or otherwise associated with priorities of respective LCHs that are associated with available uplink traffic to be transmitted. For example, packets for a higher priority LCH may be scheduled prior to packets from a lower priority LCH.

As described elsewhere herein, LCP restrictions may be designed to route (e.g., steer) a given type of traffic to network resources (e.g., a TRP, RU, carrier, and/or cell) that best serve QoS requirements of the given type of traffic. However, current LCP restrictions may provide a limited and/or unreliable mechanism for routing traffic to desired network resources. For example, the one or more LCP restrictions may include one or more serving cells via which a traffic for a given LCH can be transmitted and/or one or more carriers via which a traffic for a given LCH can be transmitted. However, these types of LCP restrictions may not reliably route traffic to a given network resource (e.g., to a given TRP or RU) because the LCP restrictions do not provide an indication or identifier of the given network resource (e.g., a cell and/or carrier may be associated with multiple TRPs or RUs). As a result, the UE may transmit traffic of an LCH (e.g., in accordance with an LCP restriction) via suboptimal network resources (e.g., network resources that do not meet one or more QoS requirements of the traffic), thereby degrading a performance of the traffic.

As another example, current LCP restrictions may be binary restrictions in that they are applied to an LCH regardless of a condition or current state of traffic for the LCH. Such restrictive or rigid LCP restrictions may degrade performance of traffic transmitted for a given LCH because the LCP restrictions may cause the UE to delay the transmission of traffic to comply with the LCP restrictions and/or to transmit the LCP restrictions using network resource(s) (e.g., a cell, a carrier, or a TRP) that is currently experiencing issues or a poor wireless communication connection with the UE. For example, if a cell or carrier via which traffic for an LCH is to be transmitted (e.g., as defined, or otherwise fixed, by an LCP restriction) is unavailable, is experiencing issues, and/or has a poor wireless communication connection with the UE, then a performance of the traffic for the LCH may be degraded (e.g., because the UE is restricted to transmitting the traffic via that cell or carrier). For example, the traffic may experience additional delays or latency because of the rigid or inflexible LCP restrictions.

Various aspects relate generally to LCP restrictions. Some aspects more specifically relate to a network node transmitting, and a UE receiving, an LCH configuration indicating one or more allowable control resource set (CORESET) groups for an LCH. In some aspects, the UE may receive an uplink grant indicating one or more uplink resources. “Uplink grant” may refer to an indication of one or more radio resources (e.g., time domain resources, frequency domain resources, or other radio resources) that are available for a UE to transmit uplink traffic (e.g., data or control information). The uplink grant may be associated with a CORESET group (e.g., may be received via a CORESET included in the CORESET group, may be configured as being associated with the CORESET group). The UE may transmit, using the one or more uplink resources, uplink data (e.g., data or control information) that is associated with the logical channel based at least in part on the one or more uplink resources, based at least in part on the CORESET group being included in the one or more allowable CORESET groups.

Particular aspects of the subject matter described in this disclosure can be implemented to realize one or more of the following potential advantages. In some examples, by configuring the one or more allowable CORESET groups, the described techniques can be used to enable traffic for the LCH to be routed to a TRP or RU that improves a performance of the traffic. For example, a CORESET group (e.g., one or more CORESETs) may be associated with a TRP or RU (e.g., in that the TRP or the RU may use the one or more CORESETs to transmit control information to the UE). By configuring an LCP restriction that defines allowable CORESET groups for an LCH, the network (e.g., one or more network nodes) may reliably route (e.g., steer) different traffic types to TRPs or RUs that best serve the different traffic types (e.g., based on QoS requirement(s) of the different traffic types). This may improve the performance of uplink traffic transmitted by the UE, because the UE is enabled to transmit the traffic to a TRP or RU that best serves the traffic (e.g., based on QoS requirement(s) of the traffic).

Some aspects described herein relate to a network node transmitting, and a UE receiving, an LCH configuration indicating one or more conditional LCP parameters (e.g., one or more conditional LCP restrictions). For example, the LCH configuration may indicate a threshold for a parameter associated with a conditional LCP restriction. The UE may transmit uplink data, associated with an LCH, in accordance with the conditional LCP restriction. An applicability of the conditional LCP restriction to the LCH is based at least in part on a value of the parameter for the uplink data satisfying the threshold. In other words, the UE may apply the conditional LCP restriction based at least in part on the value of the parameter for the uplink data satisfying the threshold. If the value of the parameter for the uplink data does not satisfy the threshold, then the UE may not apply (e.g., may refrain from applying) the conditional LCP restriction for the LCH.

In some examples, by configuring one or more conditional LCP restrictions, the described techniques can be used to enable the UE to adaptively or selectively apply LCP restrictions based on values of one or more parameters of uplink data to be transmitted. This may improve the performance of the transmission of the uplink data because the UE may transmit the uplink data using additional network resources (e.g., in addition to the network resource(s) restricted or limited by the one or more conditional LCP restrictions) based at least in part on the value of the parameter for the uplink not satisfying the threshold. For example, the parameter may be a remaining time parameter (e.g., a remaining packing delay budget, a remaining duration of a packet data convergence protocol (PDCP) discard timer, or another remaining time parameter). For example, if the remaining time parameter is less than or equal to a threshold, then the UE may not apply a conditional LCP restriction, thereby enabling the UE to transmit the uplink data (e.g., for which a packet delay budget may be shortly expiring) via additional network resources, thereby reducing a likelihood of discarding or not transmitting the uplink data due to the expiration of a timer. As another example, the parameter may be a buffer size. If a buffer size for an LCH is greater than or equal to a threshold, then the UE may not apply a conditional LCP restriction for the LCH. This may reduce a likelihood of the UE discarding data for the LCH due to the buffer size of the LCH becoming too large. In some aspects, a conditional LCP restriction may an allowable CORESET group, an allowable subcarrier spacing (SCS) index, an allowable (e.g., maximum) transmission duration, an allowable configured grant type, an allowable serving cell, an allowable configured grant, an allowable physical layer priority index, and/or an allowable hybrid automatic repeat request (HARQ) mode, among other examples.

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

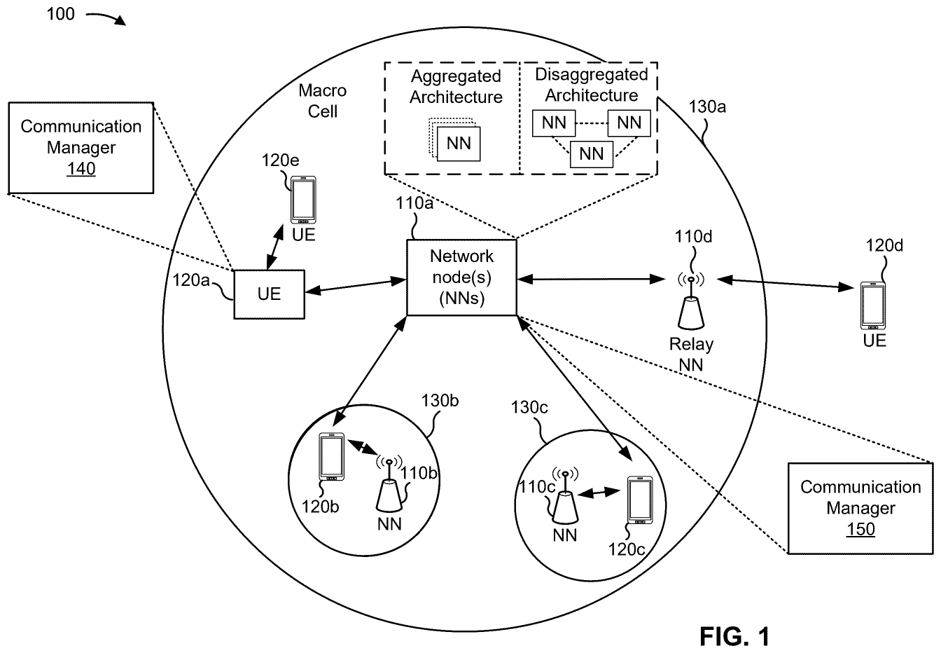

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a MAC layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c.Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive, from a network node, a logical channel configuration indicating one or more allowable CORESET groups for a logical channel; receive an uplink grant indicating one or more uplink resources, wherein the uplink grant is associated with a CORESET group; and transmit, using the one or more uplink resources, uplink data that is associated with the logical channel, wherein the uplink data being transmitted using the one or more uplink resources is based at least in part on the CORESET group being included in the one or more allowable CORESET groups. Additionally, or alternatively, as described in more detail elsewhere herein, the communication manager 140 may receive, from a network node, a logical channel configuration indicating a conditional logical channel prioritization parameter for a logical channel, wherein the logical channel configuration indicates a threshold for a parameter associated with the conditional logical channel prioritization parameter; and transmit, via the logical channel, uplink data in accordance with the conditional logical channel prioritization parameter, wherein an applicability of the conditional logical channel prioritization parameter to the logical channel is based at least in part on a value of the parameter for the uplink data satisfying the threshold. Additionally, or alternatively, the communication manager 140 may perform one or more other operations described herein.

In some aspects, the network node 110 may include a communication manager 150. As described in more detail elsewhere herein, the communication manager 150 may transmit a logical channel configuration, for a UE, indicating one or more allowable CORESET groups for a logical channel; transmit an uplink grant for the UE indicating one or more uplink resources, wherein the uplink grant is associated with a CORESET group; and receive, via the one or more uplink resources, uplink data that is associated with the logical channel, wherein the uplink data being received using the one or more uplink resources is based at least in part on the CORESET group being included in the one or more allowable CORESET groups. Additionally, or alternatively, as described in more detail elsewhere herein, the communication manager 150 may transmit a logical channel configuration indicating a conditional logical channel prioritization parameter for a logical channel, wherein the logical channel configuration indicates a threshold for a parameter associated with the conditional logical channel prioritization parameter; and receive, via the logical channel, uplink data in accordance with the conditional logical channel prioritization parameter, wherein an applicability of the conditional logical channel prioritization parameter to the logical channel is based at least in part on a value of the parameter for the uplink data satisfying the threshold. Additionally, or alternatively, the communication manager 150 may perform one or more other operations described herein.

As indicated above, FIG. 1 is provided as an example. Other examples may differ from what is described with regard to FIG. 1.

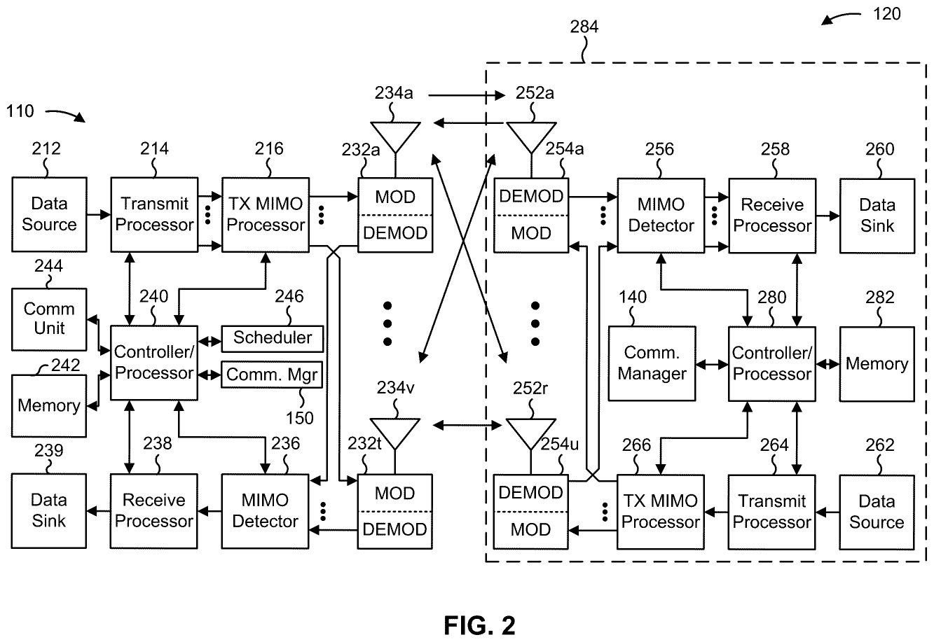

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation and coding schemes (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

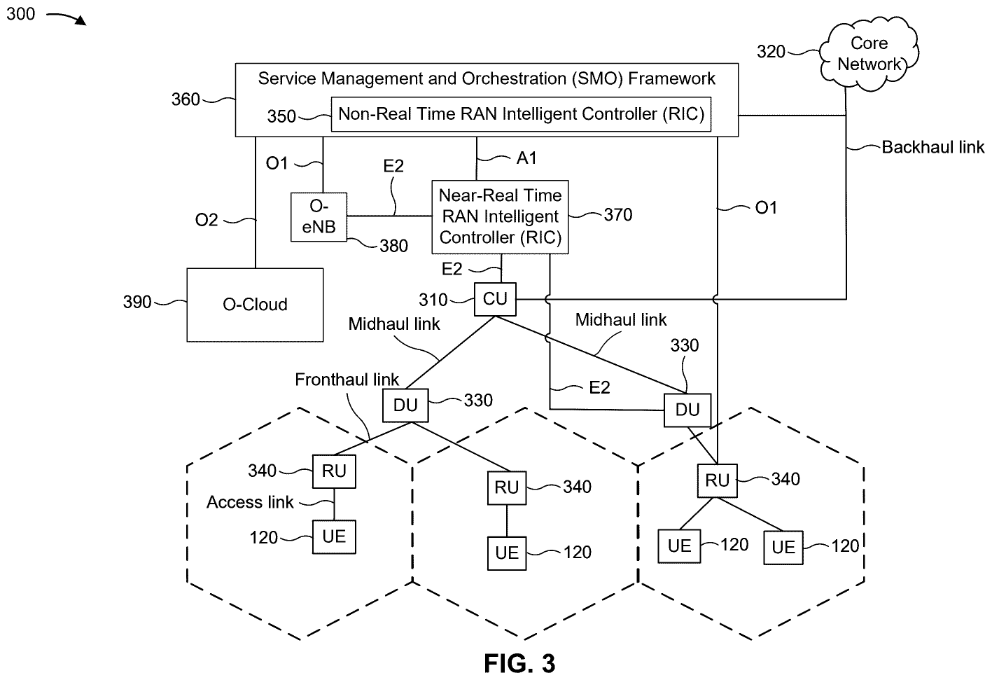

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

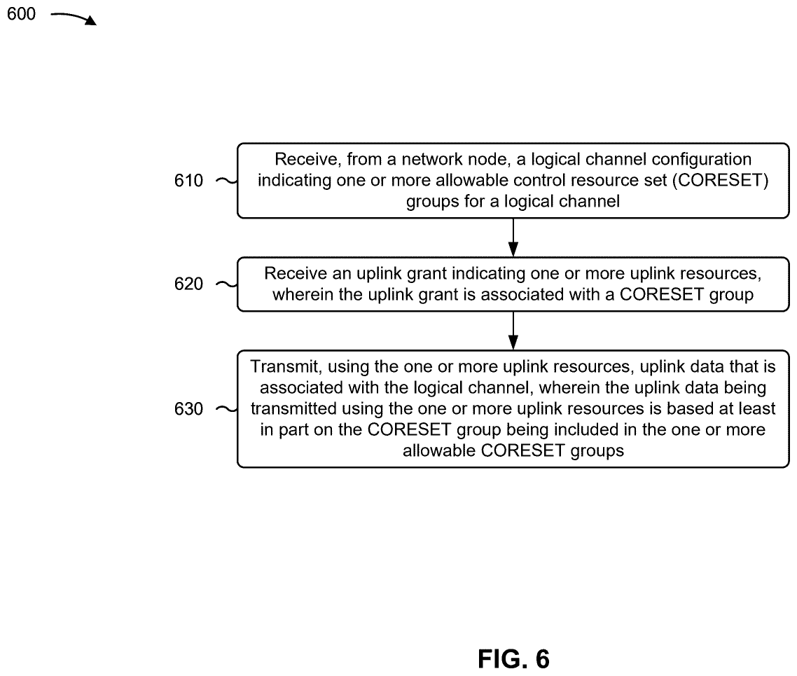

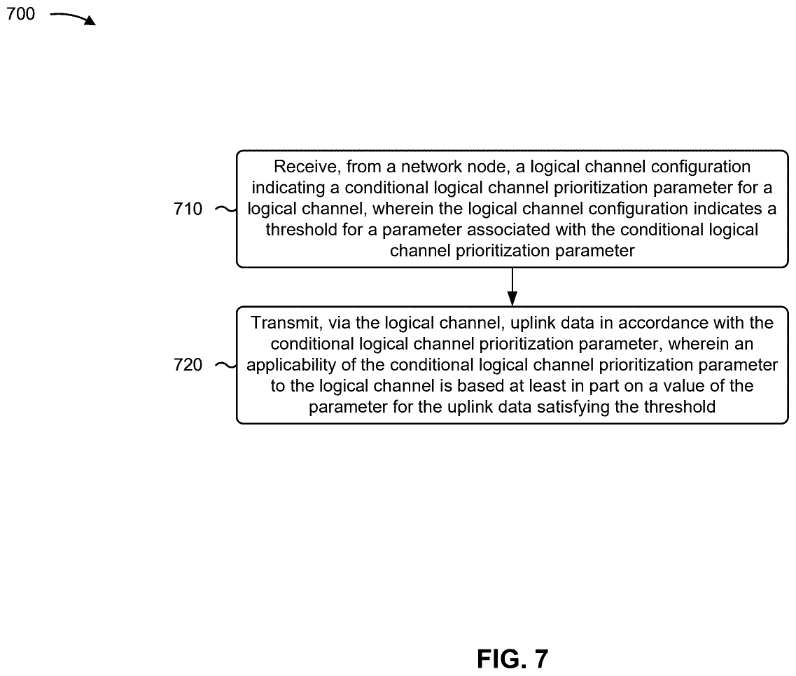

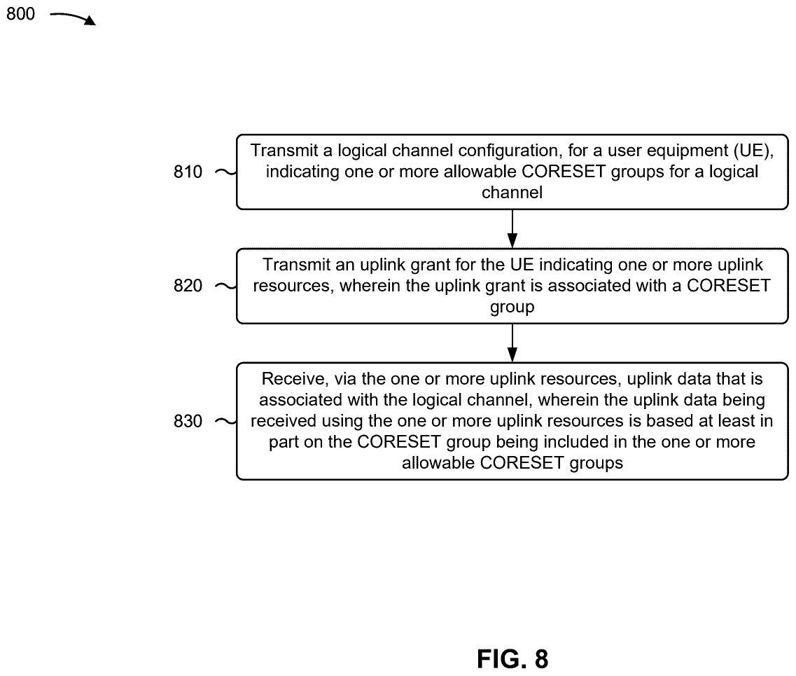

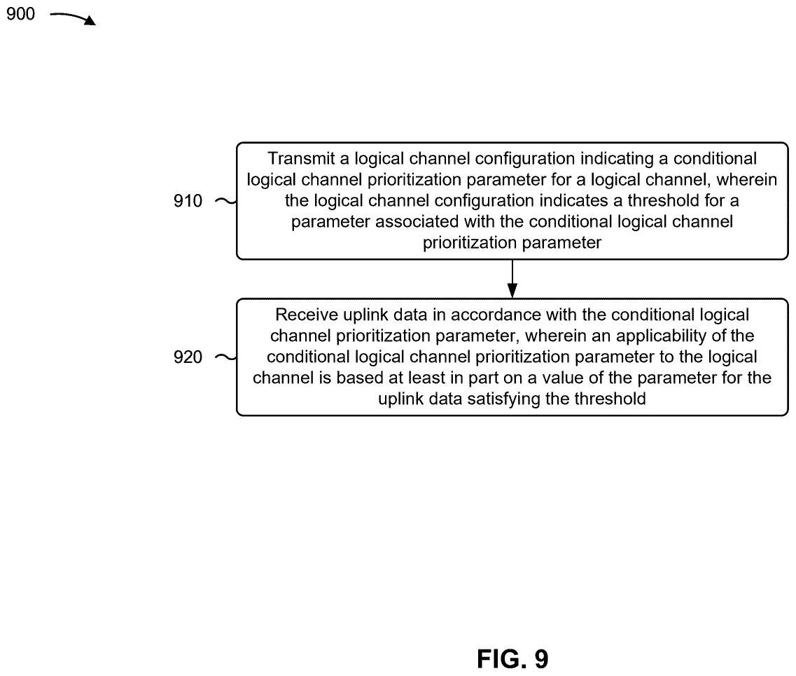

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with logical channel prioritization restrictions, as described in more detail elsewhere herein. For example, the controller/processor 240 of the network node 110, the controller/processor 280 of the UE 120, any other component(s) (or combinations of components) of FIG. 2, the CU 310, the DU 330, or the RU 340 may perform or direct operations of, for example, process 600 of FIG. 6, process 700 of FIG. 7, process 800 of FIG. 8, process 900 of FIG. 9, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 600 of FIG. 6, process 700 of FIG. 7, process 800 of FIG. 8, process 900 of FIG. 9, or other processes as described herein. In some examples, executing instructions may include running the instructions, converting the instructions, compiling the instructions, and/or interpreting the instructions, among other examples.

In some aspects, the UE 120 includes means for receiving, from a network node, a logical channel configuration indicating one or more allowable CORESET groups for a logical channel; means for receiving an uplink grant indicating one or more uplink resources, wherein the uplink grant is associated with a CORESET group; and/or means for transmitting, using the one or more uplink resources, uplink data that is associated with the logical channel, wherein the uplink data being transmitted using the one or more uplink resources is based at least in part on the CORESET group being included in the one or more allowable CORESET groups. Additionally, or alternatively, the UE 120 includes means for receiving, from a network node, a logical channel configuration indicating a conditional logical channel prioritization parameter for a logical channel, wherein the logical channel configuration indicates a threshold for a parameter associated with the conditional logical channel prioritization parameter; and/or means for transmitting, via the logical channel, uplink data in accordance with the conditional logical channel prioritization parameter, wherein an applicability of the conditional logical channel prioritization parameter to the logical channel is based at least in part on a value of the parameter for the uplink data satisfying the threshold. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting a logical channel configuration, for a UE, indicating one or more allowable CORESET groups for a logical channel; means for transmitting an uplink grant for the UE indicating one or more uplink resources, wherein the uplink grant is associated with a CORESET group; and/or means for receiving, via the one or more uplink resources, uplink data that is associated with the logical channel, wherein the uplink data being received using the one or more uplink resources is based at least in part on the CORESET group being included in the one or more allowable CORESET groups. Additionally, or alternatively, in some aspects, the network node 110 includes means for transmitting a logical channel configuration indicating a conditional logical channel prioritization parameter for a logical channel, wherein the logical channel configuration indicates a threshold for a parameter associated with the conditional logical channel prioritization parameter; and/or means for receiving, via the logical channel, uplink data in accordance with the conditional logical channel prioritization parameter, wherein an applicability of the conditional logical channel prioritization parameter to the logical channel is based at least in part on a value of the parameter for the uplink data satisfying the threshold. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

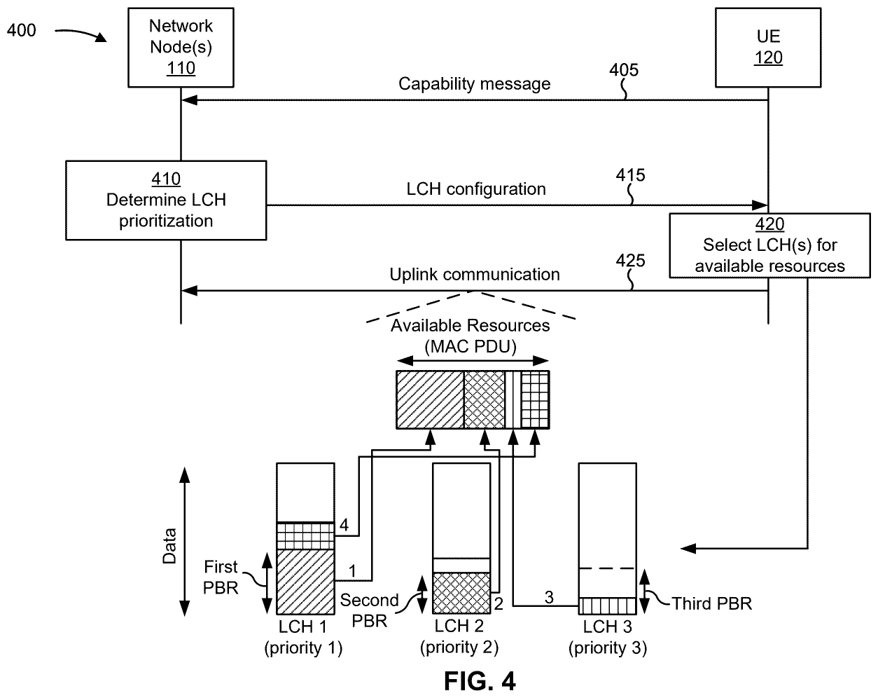

FIG. 4 is a diagram illustrating an example associated with logical channel prioritization 400, in accordance with the present disclosure. As shown in FIG. 4, one or more network nodes 110 and a UE 120 may communicate with one another (for example, via a wireless network, such as the wireless communication network 100 of FIG. 1). The network node(s) 110 may each include an RU and/or a device controlling the RU, such as a DU and/or a CU. The network node(s) 110 may each be associated with at least one TRP (for example, within a cell).

In a first operation 405, the UE 120 may transmit, and the network node(s) 110 may receive, a capability message indicating that the UE 120 is configured for LCH restrictions. For example, the capability message may include a UECapabilityInformation message, as defined in 3GPP specifications. Accordingly, the UE 120 may indicate that the UE 120 is configured for LCH restrictions using an lcp-Restriction information element (IE), as defined, or otherwise fixed, by a wireless communication standard, such as the 3GPP. In some examples, the network node(s) 110 may transmit, and the UE 120 may receive, a request for the capability message (for example, a UECapabilityEnquiry message, as defined, or otherwise fixed, by a wireless communication standard, such as the 3GPP). The UE 120 may transmit, and the network node(s) 110 may receive, the capability message based on, in response to, or otherwise associated with the request.

In a second operation 410, the network node(s) 110 may determine a logical channel prioritization (LCP) for the UE 120. The network node(s) 110 may determine priorities for respective LCHs. For example, each LCH may be associated with a priority. In some examples, the priority may be an integer value (for example, from 1 to 16, where 1 is the highest priority and 16 is the lowest priority). In some examples, the network node(s) 110 may determine at least one restriction (for example, an LCP restriction) based at least in part on a QoS requirement associated with an LCH for the UE 120. As used herein, “logical channel” or “LCH” may refer to a channel between an RLC layer and a MAC layer that facilitates downlink communications from the network node(s) 110 to the UE 120 and uplink communications from the UE 120 to the network node(s) 110. An LCH may reside in the control plane and carry control information or may reside in the user plane and carry data.

In one example, the network node(s) 110 may identify traffic that is delay-sensitive (for example, traffic for an XR application). Accordingly, the network node(s) 110 may determine a restriction for an LCH, to which the delay-sensitive traffic is assigned, that will route the delay-sensitive traffic to a physical channel (for example, to a TRP of the network node(s) 110) with higher data rate (for example, lower data load). In another example, the network node(s) 110 may identify traffic that is error-sensitive (for example, pose updates for an XR application). Accordingly, the network node(s) 110 may determine a restriction for an LCH, to which the error-sensitive traffic is assigned, that will route the error-sensitive traffic to a TRP of the network node(s) 110 with greater robustness (for example, higher quality and/or reliability). In another example, the network node(s) 110 may identify an LCH associated with control information for the UE 120. Accordingly, the network node(s) 110 may determine a restriction for the LCH, to which the control information is assigned, that will route the control information to a TRP of the network node(s) 110 with greater robustness (for example, higher quality and/or reliability).

In some examples, an application service may be a multi-modal service. The multi-modal service may be associated with multi-modal traffic. As used herein, “multi-modal traffic” may refer to traffic that is associated with multiple modes of an application. For example, some applications may generate multiple types of uplink flows of data (for example, multiple modes). For example, an application (for example, an XR application or a VR application) may generate audio data, video data, positioning data, haptic data, and/or other types of data that are each associated with the application. The different types of uplink flows may be associated with different QoS requirements. For example, video data may be associated with a high data rate, an average reliability requirement (e.g., 99%), and/or an average latency requirement (e.g., 50 milliseconds for uplink). Haptic data or control data may be associated with a low data rate, a high reliability requirement (e.g., 99.99%), and/or a stringent latency requirement (e.g., 20 milliseconds for uplink). The different types of uplink flows may be better served using different radio resources of the wireless communication network (for example, different TRPs, different RUs, or different network nodes 110). For example, a TRP or RU may be deployed near a cell edge. The TRP or RU may enable improved coverage and throughput for UEs located near the cell edge. However, traffic routed through the TRP or RU may experience additional delays or latency (e.g., as compared to traffic that is transmitted directly to a network node 110 or directly to a base station or DU, such as to a TRP or RU that is co-located with the base station or the DU). Therefore, it may be beneficial to route traffic that has higher data rates and is less sensitive to latency through the TRP or RU (e.g., to achieve a higher throughput for the traffic), such as for video traffic. For other types of traffic, such as haptic data, control data, or other types of data that are delay sensitive, it may be beneficial to route the traffic directly to a network node 110 (e.g., a base station or DU) to reduce the delay or latency for the traffic.

As another example, TRPs or RUs serving respective carriers on different bands (such as in an inter-band carrier aggregation scenario) may not be co-located. For example, traffic for a given carrier may be routed to a network node (e.g., to a base station or a DU) via one or more midhaul links or one or more backhaul links. In such examples, it may be beneficial to route different types of traffic to different carriers based on, or otherwise associated with, the QoS requirements of the different types of traffic.

In some examples, the network node(s) 110 may determine a prioritized bit rate (PBR) for each LCH. The PBR may be a data rate provided to one LCH before allocating any resources to a lower priority LCH. For example, to avoid starvation of some LCHs (for example, to avoid scenarios in which a traffic for a given LCH is unable to be transmitted because higher priority LCHs have traffic that is filling the available resources), the PBR may set a limit for each LCH. For example, when filling the available resources, the PBR may indicate an amount of data that is to be added from each LCH. If there is any remaining resources, then the available resources may be filled according to the priority of the LCHs.

In a third operation 415, the network node(s) 110 may transmit, and the UE 120 may receive, a configuration, for a set of LCHs, that indicates the at least one restriction (for an LCH in the set of LCHs). For example, in the third operation 415, the network node(s) 110 may transmit configuration information that includes an LCH configuration for one or more LCHs. An LCH configuration may include a LogicalChannelConfig RRC parameter (for example, as defined, or otherwise fixed, by the 3GPP). The LCH configuration may indicate a priority (for example, an LCH priority) and/or a PBR (for example, via a prioritisedBitRate IE) for the LCH associated with the LCH configuration.

In a fourth operation 420, the UE 120 may select one or more LCHs for traffic to transmit to the network node(s) 110. For example, different LCHs may be associated with different QoS requirements, as described above. In some examples, the UE 120 may select traffic associated with the one or more LCHs to fill available resources for an uplink transmission (for example, to fill a MAC PDU). The UE 120 may select the one or more LCHs based on, responsive to, or otherwise associated with priorities of respective LCHs that are associated with available uplink traffic to be transmitted.

For example, as shown in FIG. 4, an uplink buffer of the UE 120 may indicate that an LCH 1, an LCH 2, and an LCH 3 are associated with uplink traffic that is available to be transmitted. The LCH 1 may be associated with a priority 1 and a first PBR. The LCH 2 may be associated with a priority 2 (for example, indicating a lower priority than the priority 1) and a second PBR. The LCH 3 may be associated with a priority 3 (for example, indicating a lower priority than the priority 1 and the priority 2) and a third PBR.

In the fourth operation 420, the UE 120 may first select traffic from the LCH 1 to be included in the MAC PDU up to an amount of traffic indicated by the first PBR. The UE 120 may second select traffic from the LCH 2 to be included in the MAC PDU up to an amount of traffic indicated by the second PBR. The UE 120 may third select traffic from the LCH 3 to be included in the MAC PDU up to an amount of traffic indicated by the third PBR. As shown in FIG. 4, the LCH 3 may be associated with less traffic than the amount of traffic indicated by the third PBR, enabling the UE 120 to select all the traffic associated with the LCH 3. The UE 120 may fill any remaining space in the available resources (for example, in the MAC PDU) in accordance with the priorities of the LCHs. For example, the UE 120 may fourth fill the remaining space in the available resources (for example, in the MAC PDU) with traffic associated with the LCH 1 (for example, because the LCH 1 has the highest priority). If there are any remaining resources after adding the traffic associated with the LCH 1 to the MAC PDU, then the UE 120 may fill the remaining space in the available resources (for example, in the MAC PDU) with traffic associated with the LCH 2.

In a fifth operation 425, the UE 120 may transmit an uplink communication using the LCH(s). For example, the UE 120 may transmit the uplink communication via the available resources (for example, via the MAC PDU). The traffic (for example, data or control information) included in the uplink communication may be based on, responsive to, or otherwise associated with selection of the traffic in accordance with the LCH priorities (for example, as performed in the fourth operation 420).

As described elsewhere herein, an LCH may be configured with one or more LCP restrictions. The one or more LCP restrictions may be designed to route (e.g., steer) a given type of traffic to network resources (e.g., a TRP, RU, carrier, and/or cell) that best serve QoS requirements of the given type of traffic. However, current LCP restrictions may be a limited and/or unreliable mechanism for routing traffic to desired network resources. For example, the one or more LCP restrictions may include one or more serving cells via which a traffic for a given LCH can be transmitted and/or one or more carriers via which a traffic for a given LCH can be transmitted. However, these types of LCP restrictions may not reliably route traffic to a given network resource (e.g., to a given TRP or RU) because the LCP restrictions do not provide an indication or identifier of the given network resource (e.g., a cell and/or carrier may be associated with multiple TRPs or RUs). As a result, the UE 120 may transmit traffic of an LCH (e.g., in accordance with an LCP restriction) via suboptimal network resources (e.g., network resources that do not meet one or more QoS requirements of the traffic), thereby degrading a performance of the traffic.

As another example, current LCP restrictions may be binary restrictions in that they are applied to an LCH regardless of a condition or current state of traffic for the LCH. Such restrictive or rigid LCP restrictions may degrade performance of traffic transmitted for a given LCH because the LCP restrictions may cause the UE to delay the transmission of traffic to comply with the LCP restrictions and/or to transmit the LCP restrictions using network resource(s) (e.g., a cell, a carrier, or a TRP) that is currently experiencing issues or a poor wireless communication connection with the UE. For example, if a cell or carrier via which traffic for an LCH is to be transmitted (e.g., as defined, or otherwise fixed, by an LCP restriction) is unavailable, is experiencing issues, and/or has a poor wireless communication connection with the UE, then a performance of the traffic for the LCH may be degraded (e.g., because the UE is restricted to transmitting the traffic via that cell or carrier). For example, the traffic may experience additional delays or latency because of the rigid LCP restrictions.

As indicated above, FIG. 4 is provided as an example. Other examples may differ from what is described with regard to FIG. 4.

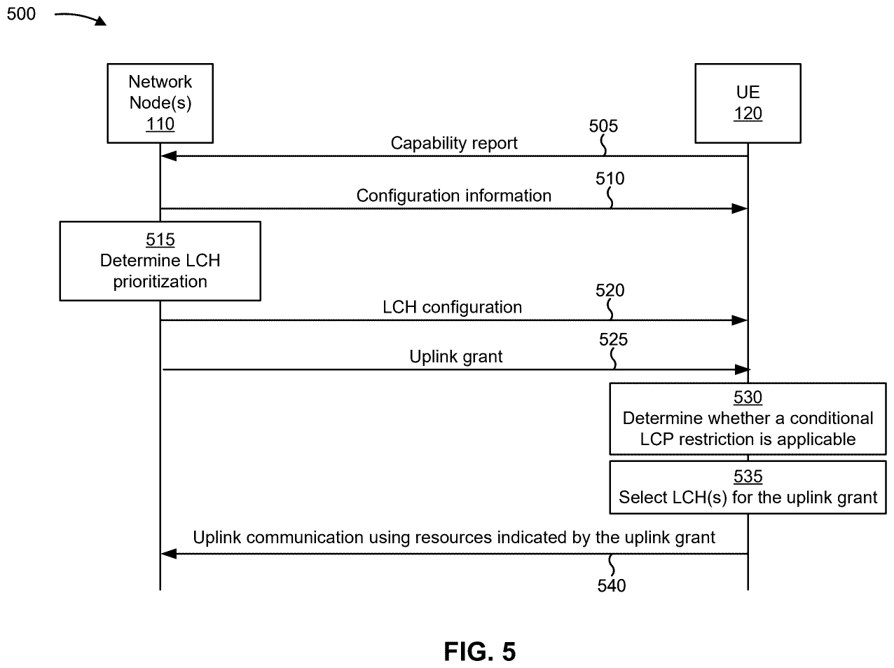

FIG. 5 is a diagram of an example 500 associated with logical channel prioritization restrictions, in accordance with the present disclosure. As shown in FIG. 5, one or more network nodes 110 (e.g., a base station, a CU, a DU, and/or an RU) may communicate with a UE 120. In some aspects, the network node(s) 110 and the UE 120 may be part of a wireless network (e.g., the wireless communication network 100). The UE 120 and the network node 110 may have established a wireless connection prior to operations shown in FIG. 5. The network node 110 may be associated with one or more TRPs and/or RUs that are deployed at different geographic locations. For example, the network node 110 may communicate (e.g., transmit or receive information) with the UE 120 via the one or more TRPs and/or RUs.

In some aspects, as shown by reference number 505, the UE 120 may transmit, and the network node 110 may receive, a capability report. The UE 120 may transmit the capability report via an uplink communication, a UE assistance information (UAI) communication, an uplink control information (UCI) communication, an uplink MAC-CE communication, an RRC communication, a physical uplink control channel (PUCCH), and/or a physical uplink shared channel (PUSCH), among other examples. The capability report may indicate one or more parameters associated with respective capabilities of the UE 120. The one or more parameters may be indicated via respective IEs included in the capability report.

The capability report may indicate whether the UE supports a feature and/or one or more parameters related to the feature. For example, the capability report may indicate a capability and/or parameter for supporting one or more LCP restrictions. As another example, the capability report may indicate a capability and/or parameter for supporting an allowable CORESET or allowable CORESET group LCP restriction. As another example, the capability report may indicate a capability and/or parameter for supporting one or more conditional LCP restrictions. One or more operations described herein may be based on capability information of the capabilities report. For example, the UE may perform a communication in accordance with the capability information, or may receive configuration information that is in accordance with the capability information. In some aspects, the capability report may indicate UE support for a CORESET group-based LCP restriction. In some aspects, the capability report may indicate UE support for one or more conditional LCP restrictions. For example, the capability report may indicate that conditional LCP restrictions are supported by the UE 120 and/or which LCP restrictions can be configured as conditional.

As shown by reference number 510, the network node 110 may transmit, and the UE 120 may receive, configuration information. In some aspects, the UE 120 may receive the configuration information via one or more of system information (e.g., a master information block (MIB) and/or a system information block (SIB), among other examples), RRC signaling, MAC signaling (e.g., one or more MAC-CEs), and/or downlink control information (DCI), among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein) may include a dynamic indication, such as one or more MAC-CEs and/or one or more DCI messages, among other examples.

In some aspects, the configuration information may indicate that the UE 120 is to perform LCP using one or more LCP restrictions. For example, the configuration information may indicate that the UE 120 is to use a CORESET-based LCP restriction, as described in more detail elsewhere herein. Additionally, or alternatively, the configuration information may indicate that the UE 120 is to use one or more conditional LCP restrictions.

The UE 120 may configure itself based at least in part on the configuration information. In some aspects, the UE 120 may be configured to perform one or more operations described herein based at least in part on the configuration information.

In some aspects, the configuration information described in connection with reference number 510 and/or the capability report described in connection with reference number 515 may include information transmitted via multiple communications. Additionally, or alternatively, the network node 110 may transmit the configuration information, or a communication including at least a portion of the configuration information, before and/or after the UE 120 transmits the capability report. For example, the network node 110 may transmit a first portion of the configuration information before the UE 120 transmits the capability report, the UE 120 may transmit at least a portion of the capability report, and the network node 110 may transmit a second portion of the configuration information after receiving the capability report.

As shown by reference number 515, the network node 110 may determine LCH prioritization. For example, the network node 110 may determine priorities for respective LCHs. For example, each LCH may be associated with a priority. In some examples, the priority may be an integer value (for example, from 1 to 16, where 1 is the highest priority and 16 is the lowest priority). In some examples, the network node(s) 110 may determine at least one restriction (for example, an LCP restriction) based at least in part on a QoS requirement associated with an LCH for the UE 120.

For example, the network node 110 may determine one or more QoS requirements associated with a traffic flow for a given LCH, such as a latency requirement, a data rate, a reliability requirement, and/or a throughput requirement, among other examples. In some aspects, the network node 110 may determine or select a TRP or RU to serve uplink traffic of the LCH for the UE 120 (e.g., an uplink TRP or an uplink RU) based at least in part on the one or more QoS requirements. The network node 110 may identify a CORESET or a CORESET group associated with the TRP or the RU. A potential control region of a slot may be referred to as a CORESET, and may be structured to support an efficient use of resources, such as by flexible configuration or reconfiguration of resources of the CORESET for one or more PDCCHs and/or one or more PDSCHs. In some aspects, the CORESET may occupy the first symbol of a slot, the first two symbols of a slot, or the first three symbols of a slot. Thus, a CORESET may include multiple resource blocks (RBs) in the frequency domain, and either one, two, or three symbols in the time domain. In 5G, a quantity of resources included in the CORESET may be flexibly configured, such as by using RRC signaling to indicate a frequency domain region (e.g., a quantity of resource blocks) and/or a time domain region (e.g., a quantity of symbols) for the CORESET.

A symbol that includes the CORESET may include one or more control channel elements (CCEs) that span a portion of the system bandwidth. A CCE may include DCI that is used to provide control information for wireless communication. A network node (e.g., a TRP or an RU) may transmit DCI during multiple CCEs, where the quantity of CCEs used for transmission of DCI represents the aggregation level (AL) used by the network node for the transmission of DCI. Each CCE may include a fixed quantity of resource element groups (REGs) or may include a variable quantity of REGs. In some aspects, the quantity of REGs included in a CCE may be specified by an REG bundle size. An REG may include one resource block, which may include 12 resource elements (REs) within a symbol. A resource element may occupy one subcarrier in the frequency domain and one OFDM symbol in the time domain.

A search space may include all possible locations (e.g., in time and/or frequency) where a PDCCH may be located. A CORESET may include one or more search spaces, such as a UE-specific search space, a group-common search space, and/or a common search space. A search space may indicate a set of CCE locations where a UE may find PDCCHs that can potentially be used to transmit control information to the UE. The possible locations for a PDCCH may depend on whether the PDCCH is a UE-specific PDCCH (e.g., for a single UE) or a group-common PDCCH (e.g., for multiple UEs) and/or an aggregation level being used. A possible location (e.g., in time and/or frequency) for a PDCCH may be referred to as a PDCCH candidate, and the set of all possible PDCCH locations at an aggregation level may be referred to as a search space. For example, the set of all possible PDCCH locations for a particular UE may be referred to as a UE-specific search space. Similarly, the set of all possible PDCCH locations across all UEs may be referred to as a common search space. The set of all possible PDCCH locations for a particular group of UEs may be referred to as a group-common search space. One or more search spaces across aggregation levels may be referred to as a search space (SS) set.

A CORESET group may include one or more CORESETs. For example, a given TRP and/or RU may be configured to transmit control information (e.g., DCI) using CORESET(s) included in a CORESET group. As a result, a given TRP and/or RU may be associated with a CORESET group in that the given TRP and/or RU is configured to transmit control information using one or more CORESETs included in the CORESET group. In some aspects, the association between CORESET groups and TRPs or RUs may be managed and/or configured by the network node 110 (or another network node 110, such as a DU or a CU). The given TRP and/or RU may not be known by the UE 120. Rather, the UE 120 may be configured with one or more CORESETs and/or CORESET groups (e.g., via the configuration information received by the UE 120 as described in connection with reference number 510) and the network node 110 may associate the CORESETs and/or CORESET groups to given TRPs and/or RUs. In other words, the association between CORESET groups and TRPs or RUs may be transparent to the UE 120. The network node 110 may configure, for the UE 120, one or more CORESETs in a CORESET group because the one or more CORESETs are configured for use for a given TRP or a given RU. This enables the network node 110 to perform scheduling, management, and/or other actions for wireless communications for the UE 120 that are communicated via a given TRP or a given RU.

The network node 110 may determine a TRP or an RU that is to receive uplink traffic from the UE 120 based on, or otherwise associated with, one or more QoS requirements of the uplink traffic. For example, the network node 110 may determine a TRP or an RU that is to receive uplink traffic for a given LCH based on, or otherwise associated with, one or more QoS requirements of a traffic flow of the given LCH. The network node 110 may determine or configure a CORESET group for the TRP or the RU. The network node 110 may determine or configure an LCP restriction that indicates that an allowable CORESET group for the given LCH includes the CORESET group for the TRP or the RU (e.g., indicating that the UE 120 is only allowed to transmit traffic of the given LCH using uplink grants that are associated with the allowable CORESET group(s)). As used herein, “allowable” CORESET group may refer to a CORESET group that includes one or more CORESETs that have associated uplink grants (e.g., DCI or configured grants) that can be used by the UE 120 to transmit uplink traffic for an LCH. This enables the network node 110 to route an uplink traffic flow of the given LCH to the TRP or the RU, as described in more detail elsewhere herein. This improves a likelihood that the UE 120 transmits uplink traffic (e.g., data or control information) via a TRP or an RU that is suited to meet the QoS requirements (e.g., data rate, throughput, reliability, and/or latency) of the uplink traffic, thereby improving the performance of the uplink traffic.

In some aspects, the network node 110 may determine one or more conditional LCP restrictions. For example, the network node 110 may configure one or more LCP restrictions to be conditional on one or more parameters of an LCH and/or of uplink traffic (e.g., one or more packets) to be transmitted. The one or more parameters may be a remaining time parameter (e.g., a shortest remaining time, a remaining packet delay budget, or a remaining duration of a PDCP discard timer for a PDU), a buffer size, or another parameter. In some aspects, the network node 110 may determine one or more thresholds for respective conditional LCP restrictions. For example, a conditional LCP restriction may be configured with one or more thresholds, where an applicability of the conditional LCP restriction is based on, or otherwise associated with, values of parameters satisfying respective thresholds of the one or more thresholds. In some aspects, the network node 110 may determine the one or more thresholds based on QoS requirements of an LCH for which the conditional LCP restriction is being configured. For example, if an LCH is associated with a first one or more QoS requirements (e.g., a first data rate, a first reliability requirement, and/or a first latency requirement), then the network node 110 may configure the conditional LCP restriction with a first threshold for a parameter (e.g., a remaining time parameter and/or a buffer size). If the LCH is associated with a second one or more QoS requirements (e.g., a second data rate, a second reliability requirement, and/or a second latency requirement), then the network node 110 may configure the conditional LCP restriction with a second threshold for the parameter.

A conditional LCP restriction may include an allowable CORESET group (e.g., an allowedCoreSetGroup LCP restriction), an allowable subcarrier spacing list (e.g., an allowedSCS-List LCP restriction), a transmission duration (e.g., a maxPUSCH-Duration LCP restriction), a configured grant type (e.g., an configuredGrantType1Allowed LCP restriction), an allowed serving cell (e.g., an allowedServingCells LCP restriction), an allowed configured grant list (e.g., an allowedCG-List LCP restriction), an allowed physical layer priority (e.g., an allowedPHY-PriorityIndex LCP restriction), and/or an allowed hybrid automatic repeat request (HARQ) mode (e.g., an allowedHARQ-mode LCP restriction), among other examples. The allowable subcarrier spacing list may indicate a list of subcarrier spacing indices associated with an uplink grant via which traffic for an LCH may be transmitted. The transmission duration may indicate an allowable transmission duration (e.g., a maximum PUSCH transmission duration) associated with an uplink grant via which traffic for an LCH may be transmitted. The configured grant type may indicate a list of one or more Type 1 configured grants via which traffic for an LCH may be transmitted. The allowed serving cell may indicate a list of one or more serving cells via which traffic for an LCH may be transmitted. The allowed configured grant list may indicate a list of one or more configured grants via which traffic for an LCH may be transmitted. The allowed physical layer priority may indicate one or more allowable physical layer priority indices for an uplink grant via which traffic for an LCH may be transmitted. The allowed HARQ mode may indicate one or more allowed uplink HARQ modes for a HARQ process of an uplink grant via which traffic for an LCH may be transmitted.

As shown by reference number 520, the network node 110 may transmit, and the UE 120 may receive, an LCH configuration. In some aspects, the LCH configuration may be included in the configuration information (e.g., transmitted by the network node 110 as described in connection with reference number 510). In other aspects, the LCH configuration may be transmitted in a communication separate from the configuration information. The LCH configuration may be included in an RRC communication. For example, the network node 110 may transmit, and the UE 120 may receive, configuration information that includes an LCH configuration for one or more LCHs. An LCH configuration may include a LogicalChannelConfig RRC parameter (for example, as defined, or otherwise fixed, by the 3GPP).

The LCH configuration may include configurations for respective LCHs. In some aspects, the configuration for a given LCH may include one or more LCP restrictions. In some aspects, the LCH configuration may include a parameter for an allowable CORESET group LCP restriction (e.g., an allowedCORESETGroup parameter in an IE of the LCH configuration). For example, the network node 110 may transmit, and the UE 120 may receive, an LCH configuration indicating one or more allowable CORESET groups for an LCH (e.g., via an allowedCORESETGroup parameter in an IE configuring the LCH). As described elsewhere herein, the one or more allowable CORESET groups may be associated with respective TRPs or respective RUs. The one or more allowable CORESET groups may be indicated via an LCP restriction (e.g., an LCP parameter).

The one or more allowable CORESET groups may indicate one or more CORESET groups for uplink grants via which uplink traffic for the LCH can be transmitted. For example, the LCH may be included in an LCP operation (e.g., an operation similar to the fourth operation 420) for uplink grants that are associated with (e.g., scheduled via or configured to be associated with) a CORESET included in the one or more CORESET groups. For example, a CORESET group L may be associated with a TRP or an RU. If a parameter in the LCH configuration indicates than an allowable CORESET group for an LCH is CORESET group L, then the UE 120 may only transmit uplink traffic for the LCH via uplink grants scheduled by or configured by the TRP or the RU. This improves the likelihood of the uplink traffic for the LCH being routed to the TRP or the RU.

Additionally, or alternatively, the LCH configuration may indicate one or more conditional LCP restrictions for one or more LCHs. In such examples, the LCH configuration may indicate one or more thresholds for respective parameters associated with the conditional LCP restriction. As described elsewhere herein, the parameter(s) may be a remaining time parameter (e.g., a remaining time to transmit a packet, a remaining packet delay budget, a remaining duration of a PDCP discard timer), and/or a buffer size, among other examples. For example, instead of a restriction being either fully allowed or completely prohibited, an LCP restriction can be configured as conditional on a state of an LCH (e.g., as indicated by the parameter(s)), such as a state of uplink traffic to be transmitted for the LCH.

As shown by reference number 525, the network node 110 may transmit (or a TRP or RU associated with the network node 110 may transmit), and the UE 120 may receive, an uplink grant. The uplink grant may be associated with a CORESET. An uplink grant may be associated with a CORESET in that the uplink grant is scheduled via the CORESET (e.g., for dynamic grants) or is configured as being associated with the CORESET (e.g., for configured grants). For example, in some aspects, the uplink grant may be a dynamic grant. For example, the uplink grant may be indicated via DCI, such as via the PDCCH. For example, the UE 120 may receive the DCI via a CORESET, as described in more detail elsewhere herein. In this way, the dynamic grant is associated with the CORESET via which the DCI is received.

In some other aspects, the uplink grant may be a configured grant. The configured grant may be indicated via configuration information, such as via an RRC configuration. For example, the configured grant may be indicated via the configuration information received by the UE 120 as described in connection with reference number 510. In such examples, the configuration of the configured grant may indicate that the configured grant is associated with a CORESET or a CORESET group. For example, the CORESET or CORESET group may be included in the configuration of the configured grant (e.g., to implicitly indicate the TRP or RU that configures the configured grant for the UE 120). In this way, the configured grant is associated with the CORESET included in the configuration of the configured grant.

In some aspects, as shown by reference number 530, the UE 120 may determine whether a conditional LCP restriction is applicable for an LCH. For example, if the LCH configuration indicates a conditional LCP restriction, then the UE 120 may determine whether the conditional LCP restriction is applicable for the LCH when selecting traffic to be transmitted via the radio resources indicated by the uplink grant. The UE 120 may determine whether the conditional LCP restriction is applicable based on values of one or more parameters of the LCH. For example, the UE 120 may determine whether the values satisfy respective thresholds indicated by the LCH configuration (e.g., for the conditional LCP restriction). If a value of a parameter satisfies the threshold indicated by the LCH configuration for the conditional LCP restriction, then the UE 120 may determine that the conditional LCP restriction is applicable. If the value of the parameter does not satisfy the threshold, then the UE 120 may determine that the conditional LCP restriction is not applicable.

In some aspects, the value may be based on, or associated with, the LCH as a whole. For example, the value may be a greatest value or a smallest value for all traffic to be transmitted for the LCH. As another example, the value may be associated with all traffic to be transmitted for the LCH, such as a buffer size of the LCH. For example, the UE 120 may determine whether the LCP restriction is applicable on a per-LCH basis (e.g., whether the LCP restriction is applicable for all traffic to be transmitted for the LCH). In some other aspects, the value may be based on, or associated with, certain traffic (e.g., packets or PDUs) for the LCH. For example, the value may be a value of a given packet to be transmitted for the LCH. For example, the UE 120 may determine whether the LCP restriction is applicable on a per-packet basis (e.g., whether the LCP restriction is applicable for a packet to be transmitted for the LCH).

As an example, the parameter may be a remaining time parameter (e.g., a remaining time to transmit traffic). If the UE 120 is determining whether the LCP restriction is applicable on a per-LCH basis, then the UE 120 may determine a smallest remaining time parameter (e.g., shortest remaining time) among all packets (e.g., all traffic) to be transmitted for the LCH. If the UE 120 is determining whether the LCP restriction is applicable on a per-packet basis, then the UE 120 may identify a remaining time parameter for a given packet. If the remaining time parameter is less than or equal to a threshold, then the UE 120 may determine that the conditional LCP restriction is not applicable (e.g., because the traffic is to be transmitted shortly, or will otherwise be lost or discarded). In such examples, the UE 120 may determine or select the LCH as part of an LCP operation (such as the fourth operation 420) without consideration of the conditional LCP restriction. This improves the likelihood that the traffic can be transmitted before a timer expires. If the remaining time parameter is greater than or equal to the threshold, then the UE 120 may determine that the conditional LCP restriction is applicable. In such examples, the UE 120 may determine or select the LCH as part of an LCP operation (such as the fourth operation 420) in accordance with the conditional LCP restriction. This ensures that the LCP restrictions configured by the network node 110 are applied when traffic for an LCH is in a normal or acceptable state.

As another example, the parameter may be a buffer size. If the buffer size is greater than or equal to a threshold, then the UE 120 may determine that the conditional LCP restriction is not applicable (e.g., because traffic for the LCH may be lost or discarded due to a large buffer size). In such examples, the UE 120 may determine or select the LCH as part of an LCP operation (such as the fourth operation 420) without consideration of the conditional LCP restriction. This improves the likelihood that the traffic can be transmitted before traffic is discarded or lost due to the large buffer size. If the buffer size is less than or equal to the threshold, then the UE 120 may determine that the conditional LCP restriction is applicable. In such examples, the UE 120 may determine or select the LCH as part of an LCP operation (such as the fourth operation 420) in accordance with the conditional LCP restriction. This ensures that the LCP restrictions configured by the network node 110 are applied when traffic for an LCH is in a normal or acceptable state.

In some aspects, the LCH configuration may indicate a secondary LCP restriction for a conditional LCP restriction. The secondary LCP restriction may be applicable in scenarios where the conditional LCP restriction is not applicable. For example, if the UE 120 determines that the conditional LCP restriction is not applicable (e.g., in a similar manner as described above), then the UE 120 may determine or select the LCH as part of an LCP operation (such as the fourth operation 420) in accordance with the secondary LCP restriction. For example, a conditional LCP restriction may indicate a first one or more allowable CORESET groups. The secondary LCP restriction may indicate a second one or more allowable CORESET groups. In some aspects, the second one or more allowable CORESET groups may include all CORESET groups configured for the UE 120. By using the secondary LCP restriction, the network node 110 may improve the likelihood of uplink traffic of an LCH being transmitted before being lost or discarded while still having some level of control of how the uplink traffic is routed via the wireless communication network.

As shown by reference number 535, the UE 120 may select one or more LCHs for the uplink grant (e.g., the uplink grant described in connection with reference number 525). For example, the UE 120 may select one or more LCHs to be included in an LCP operation (similar to the fourth operation 420) to select traffic to be transmitted via radio resources indicated by the uplink grant. The UE 120 may select the one or more LCHs based on, or otherwise associated with, one or more LCP restrictions indicated by the LCH configuration. For example, one or more LCP restrictions may include one or more conditional LCP restrictions that are determined to be applicable by the UE 120, such as described in connection with reference number 530.

As an example, the LCP restriction may include one or more allowable CORESET groups. The UE 120 may determine a CORESET group that is associated with the uplink grant (e.g., via which the uplink grant is transmitted or for which the uplink grant is configured to be associated with). The UE 120 may determine whether the CORESET group is included in one or more allowable CORESET groups indicated by an LCP restriction for an LCH (e.g., as configured via the LCH configuration). If the CORESET group is included in one or more allowable CORESET groups, then the LCH may be included in the LCP operation for the uplink grant. If the CORESET group is not included in one or more allowable CORESET groups, then the LCH may not be included in the LCP operation for the uplink grant. For example, the UE 120 may select, using logical channel prioritization, uplink data to be transmitted using one or more uplink resources indicated by the uplink grant. A logical channel may be included in the logical channel prioritization based at least in part on the CORESET group associated with the uplink grant being included in the one or more allowable CORESET groups configured for the logical channel.

The UE 120 may perform the LCP operation for selected LCHs (e.g., in accordance with the LCP restrictions configured via the LCH configuration). For example, the one or more LCHs selected by the UE 120 may include an LCH 1, an LCH 2, and an LCH 3. The LCH 1 may be associated with a priority 1 and a first PBR. The LCH 2 may be associated with a priority 2 (for example, indicating a lower priority than the priority 1) and a second PBR. The LCH 3 may be associated with a priority 3 (for example, indicating a lower priority than the priority 1 and the priority 2) and a third PBR.

The UE 120 may first select traffic from the LCH 1 to be included in the radio resources indicated by the uplink grant up to an amount of traffic indicated by the first PBR. The UE 120 may second select traffic from the LCH 2 to be included in the radio resources indicated by the uplink grant up to an amount of traffic indicated by the second PBR. The UE 120 may select third select traffic from the LCH 3 to be included in the radio resources indicated by the uplink grant up to an amount of traffic indicated by the third PBR. The UE 120 may select traffic from the one or more LCHs in a similar manner as described in connection with the fourth operation 420.

As shown by reference number 540, the UE 120 may transmit an uplink communication using radio resources indicated by the uplink grant. The uplink communication may include traffic selected from the one or more LCHs, as described above. For example, the UE 120 may transmit uplink data for a logical channel, where the uplink data being transmitted using one or more uplink resources indicated by the uplink grant is based at least in part on the CORESET group associated with the uplink grant being included in the one or more allowable CORESET groups configured for the logical channel. As another example, the UE 120 may transmit uplink data in accordance with a conditional logical channel prioritization parameter (e.g., a conditional LCP restriction), where the conditional logical channel prioritization parameter is applied for the logical channel based at least in part on a value of a parameter for the uplink data and/or the logical channel satisfying a threshold, as described in more detail elsewhere herein (such as in connection with reference number 530).

As indicated above, FIG. 5 is provided as an example. Other examples may differ from what is described with respect to FIG. 5.

FIG. 6 is a diagram illustrating an example process 600 performed, for example, at a UE or an apparatus of a UE, in accordance with the present disclosure. Example process 600 is an example where the apparatus or the UE (e.g., UE 120) performs operations associated with logical channel prioritization restrictions.

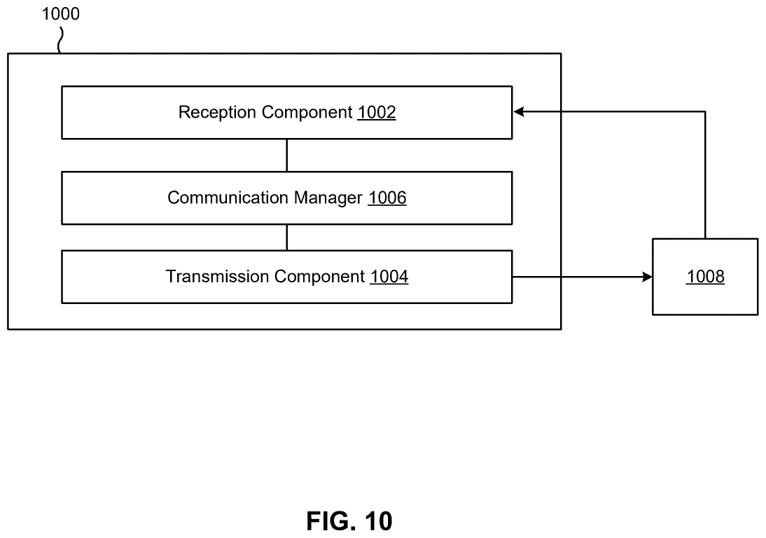

As shown in FIG. 6, in some aspects, process 600 may include receiving, from a network node, a logical channel configuration indicating one or more allowable CORESET groups for a logical channel (block 610). For example, the UE (e.g., using reception component 1002 and/or communication manager 1006, depicted in FIG. 10) may receive, from a network node, a logical channel configuration indicating one or more allowable CORESET groups for a logical channel, as described above.

As further shown in FIG. 6, in some aspects, process 600 may include receiving an uplink grant indicating one or more uplink resources, wherein the uplink grant is associated with a CORESET group (block 620). For example, the UE (e.g., using reception component 1002 and/or communication manager 1006, depicted in FIG. 10) may receive an uplink grant indicating one or more uplink resources, wherein the uplink grant is associated with a CORESET group, as described above.

As further shown in FIG. 6, in some aspects, process 600 may include transmitting, using the one or more uplink resources, uplink data that is associated with the logical channel, wherein the uplink data being transmitted using the one or more uplink resources is based at least in part on the CORESET group being included in the one or more allowable CORESET groups (block 630). For example, the UE (e.g., using transmission component 1004 and/or communication manager 1006, depicted in FIG. 10) may transmit, using the one or more uplink resources, uplink data that is associated with the logical channel, wherein the uplink data being transmitted using the one or more uplink resources is based at least in part on the CORESET group being included in the one or more allowable CORESET groups, as described above.

Process 600 may include additional aspects, such as any single aspect or any combination of aspects described below and/or in connection with one or more other processes described elsewhere herein.

In a first aspect, receiving the uplink grant includes receiving, via a CORESET included in the CORESET group, the uplink grant.

In a second aspect, alone or in combination with the first aspect, the uplink grant is a configured grant, and receiving the uplink grant includes receiving configuration information indicating that the configured grant is associated with the CORESET group.

In a third aspect, alone or in combination with one or more of the first and second aspects, transmitting the uplink data includes selecting, using logical channel prioritization, the uplink data to be transmitted using the one or more uplink resources, wherein the logical channel is included in the logical channel prioritization based at least in part on the CORESET group being included in the one or more allowable CORESET groups.

In a fourth aspect, alone or in combination with one or more of the first through third aspects, the logical channel configuration indicates a threshold for a parameter.

In a fifth aspect, alone or in combination with one or more of the first through fourth aspects, the logical channel configuration indicates that the one or more allowable CORESET groups are conditional on the threshold being satisfied.

In a sixth aspect, alone or in combination with one or more of the first through fifth aspects, transmitting the uplink data includes transmitting, using the one or more uplink resources, the uplink data in association with a value of the parameter satisfying the threshold.

In a seventh aspect, alone or in combination with one or more of the first through sixth aspects, the value of the parameter is associated with the logical channel.

In an eighth aspect, alone or in combination with one or more of the first through seventh aspects, the uplink data includes a protocol data unit (PDU), and the value of the parameter is associated with the PDU.

In a ninth aspect, alone or in combination with one or more of the first through eighth aspects, the parameter is a remaining time parameter.

In a tenth aspect, alone or in combination with one or more of the first through ninth aspects, the parameter is a buffer size.

In an eleventh aspect, alone or in combination with one or more of the first through tenth aspects, the one or more allowable CORESET groups are indicated via a logical channel prioritization parameter.

In a twelfth aspect, alone or in combination with one or more of the first through eleventh aspects, the one or more allowable CORESET groups are associated with respective transmission reception points.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a UE or an apparatus of a UE, in accordance with the present disclosure. Example process 700 is an example where the apparatus or the UE (e.g., UE 120) performs operations associated with logical channel prioritization restrictions.

As shown in FIG. 7, in some aspects, process 700 may include receiving, from a network node, a logical channel configuration indicating a conditional logical channel prioritization parameter for a logical channel, wherein the logical channel configuration indicates a threshold for a parameter associated with the conditional logical channel prioritization parameter (block 710). For example, the UE (e.g., using reception component 1002 and/or communication manager 1006, depicted in FIG. 10) may receive, from a network node, a logical channel configuration indicating a conditional logical channel prioritization parameter for a logical channel, wherein the logical channel configuration indicates a threshold for a parameter associated with the conditional logical channel prioritization parameter, as described above.

As further shown in FIG. 7, in some aspects, process 700 may include transmitting, via the logical channel, uplink data in accordance with the conditional logical channel prioritization parameter, wherein an applicability of the conditional logical channel prioritization parameter to the logical channel is based at least in part on a value of the parameter for the uplink data satisfying the threshold (block 720). For example, the UE (e.g., using transmission component 1004 and/or communication manager 1006, depicted in FIG. 10) may transmit, via the logical channel, uplink data in accordance with the conditional logical channel prioritization parameter, wherein an applicability of the conditional logical channel prioritization parameter to the logical channel is based at least in part on a value of the parameter for the uplink data satisfying the threshold, as described above.

Process 700 may include additional aspects, such as any single aspect or any combination of aspects described below and/or in connection with one or more other processes described elsewhere herein.

In a first aspect, process 700 includes selecting, using logical channel prioritization, the uplink data to be transmitted using one or more uplink resources, wherein the logical channel is included in the logical channel prioritization based at least in part on the value of the parameter satisfying the threshold.

In a second aspect, alone or in combination with the first aspect, the conditional logical channel prioritization parameter is an allowable control resource set group parameter.

In a third aspect, alone or in combination with one or more of the first and second aspects, the conditional logical channel prioritization parameter is an allowable serving cell parameter.

In a fourth aspect, alone or in combination with one or more of the first through third aspects, the conditional logical channel prioritization parameter is an allowable subcarrier spacing list parameter.

In a fifth aspect, alone or in combination with one or more of the first through fourth aspects, the conditional logical channel prioritization parameter is a transmission duration parameter.

In a sixth aspect, alone or in combination with one or more of the first through fifth aspects, the conditional logical channel prioritization parameter is a configured grant type parameter.

In a seventh aspect, alone or in combination with one or more of the first through sixth aspects, the conditional logical channel prioritization parameter is an allowed configured grant list parameter.

In an eighth aspect, alone or in combination with one or more of the first through seventh aspects, the conditional logical channel prioritization parameter is an allowed physical layer priority parameter.

In a ninth aspect, alone or in combination with one or more of the first through eighth aspects, the conditional logical channel prioritization parameter is an allowed HARQ mode parameter.

In a tenth aspect, alone or in combination with one or more of the first through ninth aspects, the parameter is a remaining time parameter.

In an eleventh aspect, alone or in combination with one or more of the first through tenth aspects, the parameter is a buffer size.

In a twelfth aspect, alone or in combination with one or more of the first through eleventh aspects, the logical channel configuration indicates one or more secondary logical channel prioritization parameters for the logical channel that are applicable if the threshold is not satisfied.

In a thirteenth aspect, alone or in combination with one or more of the first through twelfth aspects, the value of the parameter is associated with the logical channel.

In a fourteenth aspect, alone or in combination with one or more of the first through thirteenth aspects, the uplink data includes a PDU, and the value of the parameter is associated with the PDU.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network node or an apparatus of a network node, in accordance with the present disclosure. Example process 800 is an example where the apparatus or the network node (e.g., network node 110) performs operations associated with logical channel prioritization restrictions.

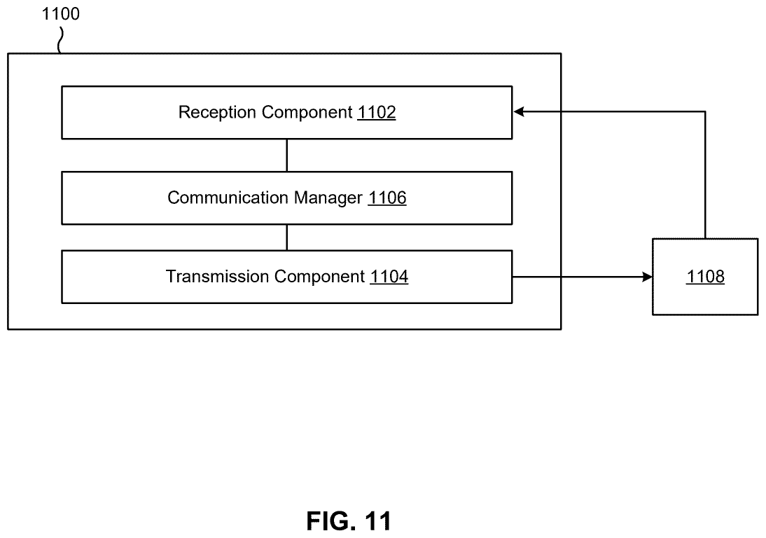

As shown in FIG. 8, in some aspects, process 800 may include transmitting a logical channel configuration, for a UE, indicating one or more allowable CORESET groups for a logical channel (block 810). For example, the network node (e.g., using communication manager 1106, depicted in FIG. 11) may transmit a logical channel configuration, for a UE, indicating one or more allowable CORESET groups for a logical channel, as described above.

As further shown in FIG. 8, in some aspects, process 800 may include transmitting an uplink grant for the UE indicating one or more uplink resources, wherein the uplink grant is associated with a CORESET group (block 820). For example, the network node (e.g., using transmission component 1104 and/or communication manager 1106, depicted in FIG. 11) may transmit an uplink grant for the UE indicating one or more uplink resources, wherein the uplink grant is associated with a CORESET group, as described above.

As further shown in FIG. 8, in some aspects, process 800 may include receiving, via the one or more uplink resources, uplink data that is associated with the logical channel, wherein the uplink data being received using the one or more uplink resources is based at least in part on the CORESET group being included in the one or more allowable CORESET groups (block 830). For example, the network node (e.g., using reception component 1102 and/or communication manager 1106, depicted in FIG. 11) may receive, via the one or more uplink resources, uplink data that is associated with the logical channel, wherein the uplink data being received using the one or more uplink resources is based at least in part on the CORESET group being included in the one or more allowable CORESET groups, as described above.

Process 800 may include additional aspects, such as any single aspect or any combination of aspects described below and/or in connection with one or more other processes described elsewhere herein.

In a first aspect, receiving the uplink grant includes transmitting, via a CORESET included in the CORESET group, the uplink grant.

In a second aspect, alone or in combination with the first aspect, the uplink grant is a configured grant, and transmitting the uplink grant includes transmitting configuration information indicating that the configured grant is associated with the CORESET group.

In a third aspect, alone or in combination with one or more of the first and second aspects, the logical channel configuration indicates a threshold for a parameter.

In a fourth aspect, alone or in combination with one or more of the first through third aspects, the logical channel configuration indicates that the one or more allowable CORESET groups are conditional on the threshold being satisfied.

In a fifth aspect, alone or in combination with one or more of the first through fourth aspects, receiving the uplink data includes receiving, via the one or more uplink resources, the uplink data in association with a value of the parameter satisfying the threshold.

In a sixth aspect, alone or in combination with one or more of the first through fifth aspects, the value of the parameter is associated with the logical channel.

In a seventh aspect, alone or in combination with one or more of the first through sixth aspects, the uplink data includes a PDU, and the value of the parameter is associated with the PDU.

In an eighth aspect, alone or in combination with one or more of the first through seventh aspects, the parameter is a remaining time parameter.

In a ninth aspect, alone or in combination with one or more of the first through eighth aspects, the parameter is a buffer size.

In a tenth aspect, alone or in combination with one or more of the first through ninth aspects, the one or more allowable CORESET groups are indicated via a logical channel prioritization parameter.

In an eleventh aspect, alone or in combination with one or more of the first through tenth aspects, the one or more allowable CORESET groups are associated with respective transmission reception points.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node or an apparatus of a network node, in accordance with the present disclosure. Example process 900 is an example where the apparatus or the network node (e.g., network node 110) performs operations associated with logical channel prioritization restrictions.

As shown in FIG. 9, in some aspects, process 900 may include transmitting a logical channel configuration indicating a conditional logical channel prioritization parameter for a logical channel, wherein the logical channel configuration indicates a threshold for a parameter associated with the conditional logical channel prioritization parameter (block 910). For example, the network node (e.g., using transmission component 1104 and/or communication manager 1106, depicted in FIG. 11) may transmit a logical channel configuration indicating a conditional logical channel prioritization parameter for a logical channel, wherein the logical channel configuration indicates a threshold for a parameter associated with the conditional logical channel prioritization parameter, as described above.

As further shown in FIG. 9, in some aspects, process 900 may include receiving uplink data in accordance with the conditional logical channel prioritization parameter, wherein the uplink data is associated with the logical channel, and wherein an applicability of the conditional logical channel prioritization parameter to the logical channel is based at least in part on a value of the parameter for the uplink data satisfying the threshold (block 920). For example, the network node (e.g., using reception component 1102 and/or communication manager 1106, depicted in FIG. 11) may receive uplink data in accordance with the conditional logical channel prioritization parameter, wherein the uplink data is associated with the logical channel, and wherein an applicability of the conditional logical channel prioritization parameter to the logical channel is based at least in part on a value of the parameter for the uplink data satisfying the threshold, as described above.

Process 900 may include additional aspects, such as any single aspect or any combination of aspects described below and/or in connection with one or more other processes described elsewhere herein.

In a first aspect, the conditional logical channel prioritization parameter is an allowable control resource set group parameter.

In a second aspect, alone or in combination with the first aspect, the conditional logical channel prioritization parameter is an allowable serving cell parameter.

In a third aspect, alone or in combination with one or more of the first and second aspects, the conditional logical channel prioritization parameter is an allowable subcarrier spacing list parameter.

In a fourth aspect, alone or in combination with one or more of the first through third aspects, the conditional logical channel prioritization parameter is a transmission duration parameter.

In a fifth aspect, alone or in combination with one or more of the first through fourth aspects, the conditional logical channel prioritization parameter is a configured grant type parameter.

In a sixth aspect, alone or in combination with one or more of the first through fifth aspects, the conditional logical channel prioritization parameter is an allowed configured grant list parameter.

In a seventh aspect, alone or in combination with one or more of the first through sixth aspects, the conditional logical channel prioritization parameter is an allowed physical layer priority parameter.

In an eighth aspect, alone or in combination with one or more of the first through seventh aspects, the conditional logical channel prioritization parameter is an allowed HARQ mode parameter.

In a ninth aspect, alone or in combination with one or more of the first through eighth aspects, the parameter is a remaining time parameter.

In a tenth aspect, alone or in combination with one or more of the first through ninth aspects, the parameter is a buffer size.

In an eleventh aspect, alone or in combination with one or more of the first through tenth aspects, the logical channel configuration indicates one or more secondary logical channel prioritization parameters for the logical channel that are applicable if the threshold is not satisfied.

In a twelfth aspect, alone or in combination with one or more of the first through eleventh aspects, the value of the parameter is associated with the logical channel.

In a thirteenth aspect, alone or in combination with one or more of the first through twelfth aspects, the uplink data includes a PDU, and the value of the parameter is associated with the PDU.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIG. 5. Additionally, or alternatively, the apparatus 1000 may be configured to perform one or more processes described herein, such as process 600 of FIG. 6, process 700 of FIG. 7, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1004 may be co-located with the reception component 1002 in one or more transceivers.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive, from a network node, a logical channel configuration indicating one or more allowable CORESET groups for a logical channel. The reception component 1002 may receive an uplink grant indicating one or more uplink resources, wherein the uplink grant is associated with a CORESET group. The transmission component 1004 may transmit, using the one or more uplink resources, uplink data that is associated with the logical channel, wherein the uplink data being transmitted using the one or more uplink resources is based at least in part on the CORESET group being included in the one or more allowable CORESET groups.

The reception component 1002 may receive, from a network node, a logical channel configuration indicating a conditional logical channel prioritization parameter for a logical channel, wherein the logical channel configuration indicates a threshold for a parameter associated with the conditional logical channel prioritization parameter. The transmission component 1004 may transmit, via the logical channel, uplink data in accordance with the conditional logical channel prioritization parameter, wherein an applicability of the conditional logical channel prioritization parameter to the logical channel is based at least in part on a value of the parameter for the uplink data satisfying the threshold.

The communication manager 1006 may select, using logical channel prioritization, the uplink data to be transmitted using one or more uplink resources, wherein the logical channel is included in the logical channel prioritization based at least in part on the value of the parameter satisfying the threshold.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIG. 5. Additionally, or alternatively, the apparatus 1100 may be configured to perform one or more processes described herein, such as process 800 of FIG. 8, process 900 of FIG. 9, or a combination thereof. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The communication manager 1106 may transmit a logical channel configuration, for a UE, indicating one or more allowable CORESET groups for a logical channel. The transmission component 1104 may transmit an uplink grant for the UE indicating one or more uplink resources, wherein the uplink grant is associated with a CORESET group. The reception component 1102 may receive, via the one or more uplink resources, uplink data that is associated with the logical channel, wherein the uplink data being received using the one or more uplink resources is based at least in part on the CORESET group being included in the one or more allowable CORESET groups.

The transmission component 1104 may transmit a logical channel configuration indicating a conditional logical channel prioritization parameter for a logical channel, wherein the logical channel configuration indicates a threshold for a parameter associated with the conditional logical channel prioritization parameter. The reception component 1102 may receive uplink data in accordance with the conditional logical channel prioritization parameter, wherein the uplink data is associated with the logical channel, and wherein an applicability of the conditional logical channel prioritization parameter to the logical channel is based at least in part on a value of the parameter for the uplink data satisfying the threshold.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving, from a network node, a logical channel configuration indicating one or more allowable control resource set (CORESET) groups for a logical channel; receiving an uplink grant indicating one or more uplink resources, wherein the uplink grant is associated with a CORESET group; and transmitting, using the one or more uplink resources, uplink data that is associated with the logical channel, wherein the uplink data being transmitted using the one or more uplink resources is based at least in part on the CORESET group being included in the one or more allowable CORESET groups.

Aspect 2: The method of Aspect 1, wherein receiving the uplink grant comprises: receiving, via a CORESET included in the CORESET group, the uplink grant.

Aspect 3: The method of any of Aspects 1-2, wherein the uplink grant is a configured grant, and wherein receiving the uplink grant comprises: receiving configuration information indicating that the configured grant is associated with the CORESET group.

Aspect 4: The method of any of Aspects 1-3, wherein transmitting the uplink data comprises: selecting, using logical channel prioritization, the uplink data to be transmitted using the one or more uplink resources, wherein the logical channel is included in the logical channel prioritization based at least in part on the CORESET group being included in the one or more allowable CORESET groups.

Aspect 5: The method of any of Aspects 1-4, wherein the logical channel configuration indicates a threshold for a parameter.

Aspect 6: The method of Aspect 5, wherein the logical channel configuration indicates that the one or more allowable CORESET groups are conditional on the threshold being satisfied.

Aspect 7: The method of any of Aspects 5-6, wherein transmitting the uplink data comprises: transmitting, using the one or more uplink resources, the uplink data in association with a value of the parameter satisfying the threshold.

Aspect 8: The method of Aspect 7, wherein the value of the parameter is associated with the logical channel.

Aspect 9: The method of any of Aspects 7-8, wherein the uplink data includes a protocol data unit (PDU), and wherein the value of the parameter is associated with the PDU.

Aspect 10: The method of any of Aspects 5-9, wherein the parameter is a remaining time parameter.

Aspect 11: The method of any of Aspects 5-10, wherein the parameter is a buffer size.

Aspect 12: The method of any of Aspects 1-11, wherein the one or more allowable CORESET groups are indicated via a logical channel prioritization parameter.

Aspect 13: The method of any of Aspects 1-12, wherein the one or more allowable CORESET groups are associated with respective transmission reception points.

Aspect 14: A method of wireless communication performed by a user equipment (UE), comprising: receiving, from a network node, a logical channel configuration indicating a conditional logical channel prioritization parameter for a logical channel, wherein the logical channel configuration indicates a threshold for a parameter associated with the conditional logical channel prioritization parameter; and transmitting, via the logical channel, uplink data in accordance with the conditional logical channel prioritization parameter, wherein an applicability of the conditional logical channel prioritization parameter to the logical channel is based at least in part on a value of the parameter for the uplink data satisfying the threshold.

Aspect 15: The method of Aspect 14, further comprising: selecting, using logical channel prioritization, the uplink data to be transmitted using one or more uplink resources, wherein the logical channel is included in the logical channel prioritization based at least in part on the value of the parameter satisfying the threshold.

Aspect 16: The method of any of Aspects 14-15, wherein the conditional logical channel prioritization parameter is an allowable control resource set group parameter.

Aspect 17: The method of any of Aspects 14-16, wherein the conditional logical channel prioritization parameter is an allowable serving cell parameter.

Aspect 18: The method of any of Aspects 14-17, wherein the conditional logical channel prioritization parameter is an allowable subcarrier spacing list parameter.

Aspect 19: The method of any of Aspects 14-18, wherein the conditional logical channel prioritization parameter is a transmission duration parameter.

Aspect 20: The method of any of Aspects 14-19, wherein the conditional logical channel prioritization parameter is a configured grant type parameter.

Aspect 21: The method of any of Aspects 14-20, wherein the conditional logical channel prioritization parameter is an allowed configured grant list parameter.

Aspect 22: The method of any of Aspects 14-21, wherein the conditional logical channel prioritization parameter is an allowed physical layer priority parameter.

Aspect 23: The method of any of Aspects 14-22, wherein the conditional logical channel prioritization parameter is an allowed hybrid automatic repeat request (HARQ) mode parameter.

Aspect 24: The method of any of Aspects 14-23, wherein the parameter is a remaining time parameter.

Aspect 25: The method of any of Aspects 14-24, wherein the parameter is a buffer size.

Aspect 26: The method of any of Aspects 14-25, wherein the logical channel configuration indicates one or more secondary logical channel prioritization parameters for the logical channel that are applicable if the threshold is not satisfied.

Aspect 27: The method of any of Aspects 14-26, wherein the value of the parameter is associated with the logical channel.

Aspect 28: The method of any of Aspects 14-27, wherein the uplink data includes a protocol data unit (PDU), and wherein the value of the parameter is associated with the PDU.

Aspect 29: A method of wireless communication performed by a network node, comprising: transmitting a logical channel configuration, for a user equipment (UE), indicating one or more allowable control resource set (CORESET) groups for a logical channel; transmitting an uplink grant for the UE indicating one or more uplink resources, wherein the uplink grant is associated with a CORESET group; and receiving, via the one or more uplink resources, uplink data that is associated with the logical channel, wherein the uplink data being received using the one or more uplink resources is based at least in part on the CORESET group being included in the one or more allowable CORESET groups.

Aspect 30: The method of Aspect 29, wherein receiving the uplink grant comprises: transmitting, via a CORESET included in the CORESET group, the uplink grant.

Aspect 31: The method of any of Aspects 29-30, wherein the uplink grant is a configured grant, and wherein transmitting the uplink grant comprises: transmitting configuration information indicating that the configured grant is associated with the CORESET group.

Aspect 32: The method of any of Aspects 29-31, wherein the logical channel configuration indicates a threshold for a parameter.

Aspect 33: The method of Aspect 32, wherein the logical channel configuration indicates that the one or more allowable CORESET groups are conditional on the threshold being satisfied.

Aspect 34: The method of any of Aspects 32-33, wherein receiving the uplink data comprises: receiving, via the one or more uplink resources, the uplink data in association with a value of the parameter satisfying the threshold.

Aspect 35: The method of Aspect 34, wherein the value of the parameter is associated with the logical channel.

Aspect 36: The method of any of Aspects 34-35, wherein the uplink data includes a protocol data unit (PDU), and wherein the value of the parameter is associated with the PDU.

Aspect 37: The method of any of Aspects 32-36, wherein the parameter is a remaining time parameter.

Aspect 38: The method of any of Aspects 32-37, wherein the parameter is a buffer size.

Aspect 39: The method of any of Aspects 29-38, wherein the one or more allowable CORESET groups are indicated via a logical channel prioritization parameter.

Aspect 40: The method of any of Aspects 29-39, wherein the one or more allowable CORESET groups are associated with respective transmission reception points.

Aspect 41: A method of wireless communication performed by a network node, comprising: transmitting a logical channel configuration indicating a conditional logical channel prioritization parameter for a logical channel, wherein the logical channel configuration indicates a threshold for a parameter associated with the conditional logical channel prioritization parameter; and receiving uplink data in accordance with the conditional logical channel prioritization parameter, wherein the uplink data is associated with the logical channel, and wherein an applicability of the conditional logical channel prioritization parameter to the logical channel is based at least in part on a value of the parameter for the uplink data satisfying the threshold.

Aspect 42: The method of Aspect 41, wherein the conditional logical channel prioritization parameter is an allowable control resource set group parameter.

Aspect 43: The method of any of Aspects 41-42, wherein the conditional logical channel prioritization parameter is an allowable serving cell parameter.

Aspect 44: The method of any of Aspects 41-43, wherein the conditional logical channel prioritization parameter is an allowable subcarrier spacing list parameter.

Aspect 45: The method of any of Aspects 41-44, wherein the conditional logical channel prioritization parameter is a transmission duration parameter.

Aspect 46: The method of any of Aspects 41-45, wherein the conditional logical channel prioritization parameter is a configured grant type parameter.

Aspect 47: The method of any of Aspects 41-46, wherein the conditional logical channel prioritization parameter is an allowed configured grant list parameter.

Aspect 48: The method of any of Aspects 41-47, wherein the conditional logical channel prioritization parameter is an allowed physical layer priority parameter.

Aspect 49: The method of any of Aspects 41-48, wherein the conditional logical channel prioritization parameter is an allowed hybrid automatic repeat request (HARQ) mode parameter.

Aspect 50: The method of any of Aspects 41-49, wherein the parameter is a remaining time parameter.

Aspect 51: The method of any of Aspects 41-50, wherein the parameter is a buffer size.

Aspect 52: The method of any of Aspects 41-51, wherein the logical channel configuration indicates one or more secondary logical channel prioritization parameters for the logical channel that are applicable if the threshold is not satisfied.

Aspect 53: The method of any of Aspects 41-52, wherein the value of the parameter is associated with the logical channel.

Aspect 54: The method of any of Aspects 41-53, wherein the uplink data includes a protocol data unit (PDU), and wherein the value of the parameter is associated with the PDU.

Aspect 55: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-54.

Aspect 56: An apparatus for wireless communication at a device, the apparatus comprising one or more memories and one or more processors coupled to the one or more memories, the one or more processors configured to cause the device to perform the method of one or more of Aspects 1-54.

Aspect 57: An apparatus for wireless communication, the apparatus comprising at least one means for performing the method of one or more of Aspects 1-54.

Aspect 58: A non-transitory computer-readable medium storing code for wireless communication, the code comprising instructions executable by one or more processors to perform the method of one or more of Aspects 1-54.

Aspect 59: A non-transitory computer-readable medium storing a set of instructions for wireless communication, the set of instructions comprising one or more instructions that, when executed by one or more processors of a device, cause the device to perform the method of one or more of Aspects 1-54.

Aspect 60: A device for wireless communication, the device comprising a processing system that includes one or more processors and one or more memories coupled with the one or more processors, the processing system configured to cause the device to perform the method of one or more of Aspects 1-54.

Aspect 61: An apparatus for wireless communication at a device, the apparatus comprising one or more memories and one or more processors coupled to the one or more memories, the one or more processors individually or collectively configured to cause the device to perform the method of one or more of Aspects 1-54.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. An apparatus for wireless communication, comprising:
one or more memories; and
one or more processors coupled to the one or more memories, the one or more processors individually or collectively configured to:
receive, from a network node, a logical channel configuration indicating one or more allowable control resource set (CORESET) groups for a logical channel;
receive an uplink grant indicating one or more uplink resources, wherein the uplink grant is associated with a CORESET group; and
transmit, using the one or more uplink resources, uplink data that is associated with the logical channel, wherein the uplink data being transmitted using the one or more uplink resources is based at least in part on the CORESET group being included in the one or more allowable CORESET groups.

2. The apparatus of claim 1, wherein the one or more processors, to receive the uplink grant, are individually or collectively configured to:
receive, via a CORESET included in the CORESET group, the uplink grant.

3. The apparatus of claim 1, wherein the uplink grant is a configured grant, and wherein the one or more processors, to receive the uplink grant, are individually or collectively configured to:
receive configuration information indicating that the configured grant is associated with the CORESET group.

4. The apparatus of claim 1, wherein the one or more processors, to transmit the uplink data, are individually or collectively configured to:
select, using logical channel prioritization, the uplink data to be transmitted using the one or more uplink resources, wherein the logical channel is included in the logical channel prioritization based at least in part on the CORESET group being included in the one or more allowable CORESET groups.

5. The apparatus of claim 1, wherein the logical channel configuration indicates a threshold for a parameter.

6. The apparatus of claim 5, wherein the logical channel configuration indicates that the one or more allowable CORESET groups are conditional on the threshold being satisfied.

7. The apparatus of claim 5, wherein the one or more processors, to transmit the uplink data, are individually or collectively configured to:
transmit, using the one or more uplink resources, the uplink data in association with a value of the parameter satisfying the threshold.

8. The apparatus of claim 7, wherein the value of the parameter is associated with the logical channel.

9. The apparatus of claim 7, wherein the uplink data includes a protocol data unit (PDU), and wherein the value of the parameter is associated with the PDU.

10. The apparatus of claim 5, wherein the parameter is a remaining time parameter.

11. The apparatus of claim 5, wherein the parameter is a buffer size.

12. An apparatus for wireless communication, comprising:
one or more memories; and
one or more processors coupled to the one or more memories, the one or more processors individually or collectively configured to:
receive, from a network node, a logical channel configuration indicating a conditional logical channel prioritization parameter for a logical channel, wherein the logical channel configuration indicates a threshold for a parameter associated with the conditional logical channel prioritization parameter; and
transmit, via the logical channel, uplink data in accordance with the conditional logical channel prioritization parameter, wherein an applicability of the conditional logical channel prioritization parameter to the logical channel is based at least in part on a value of the parameter for the uplink data satisfying the threshold.

13. The apparatus of claim 12, wherein the one or more processors are further individually or collectively configured to:
select, using logical channel prioritization, the uplink data to be transmitted using one or more uplink resources, wherein the logical channel is included in the logical channel prioritization based at least in part on the value of the parameter satisfying the threshold.

14. The apparatus of claim 12, wherein the conditional logical channel prioritization parameter is at least one of:
an allowable control resource set group parameter,
an allowable serving cell parameter,
an allowable subcarrier spacing list parameter,
a transmission duration parameter,
a configured grant type parameter,
an allowed configured grant list parameter,
an allowed physical layer priority parameter, or
an allowed hybrid automatic repeat request (HARQ) mode parameter.

15. The apparatus of claim 12, wherein the parameter is a remaining time parameter.

16. The apparatus of claim 12, wherein the parameter is a buffer size.

17. The apparatus of claim 12, wherein the logical channel configuration indicates one or more secondary logical channel prioritization parameters for the logical channel that are applicable if the threshold is not satisfied.

18. A method of wireless communication performed by a user equipment (UE), comprising:
receiving, from a network node, a logical channel configuration indicating one or more allowable control resource set (CORESET) groups for a logical channel;
receiving an uplink grant indicating one or more uplink resources, wherein the uplink grant is associated with a CORESET group; and
transmitting, using the one or more uplink resources, uplink data that is associated with the logical channel, wherein the uplink data being transmitted using the one or more uplink resources is based at least in part on the CORESET group being included in the one or more allowable CORESET groups.

19. The method of claim 18, wherein transmitting the uplink data comprises:
selecting, using logical channel prioritization, the uplink data to be transmitted using the one or more uplink resources, wherein the logical channel is included in the logical channel prioritization based at least in part on the CORESET group being included in the one or more allowable CORESET groups.

20. The method of claim 18, wherein the logical channel configuration indicates a threshold for a parameter, and wherein the logical channel configuration indicates that the one or more allowable CORESET groups are conditional on the threshold being satisfied.
